(19) United States
(12) Patent Application Publication
(10) Pub. No.: US 2026/0310595 A1
(43) Pub. Date: Oct. 8, 2026

(54) SYSTEMS AND METHODS FOR ROOT CAUSE FAILURE IDENTIFICATION USING MULTI-STAGE RETRIEVAL-AUGMENTED GENERATION

(71) Applicant: NVIDIA Corporation, Santa Clara, CA (US)

(72) Inventors: Prashant Sanjay BHENDE, Maharashtra (IN); Oswin Jerome SAMUEL, Maharashtra (IN); Santhosh Kumar CHARUGULLA, Pune Maharashtra (IN)

(21) Appl. No.: 19/170,398

(22) Filed: Apr. 4, 2025

(51) Int. Cl. G06F 11/3668

(52) U.S. Cl. CPC G06F 11/3692; G06F 11/3684; G06F 11/3688

(57) ABSTRACT

In various examples, systems and methods for root cause failure identification using multi-stage retrieval-augmented generation are provided. A multi-stage retrieval-augmented generation system may include first model(s) that may extract a first context from test log(s) including a test failure based on first prompt(s) and information retrieved from first database(s). The multi-stage retrieval-augmented generation system may also include second model(s) that may extract a second context from product log(s) corresponding to the test log(s) based on the first context extracted from the test log(s), second prompt(s), and information retrieved from second database(s). Operation(s) for addressing the test failure may be performed based on the second context extracted from the product log(s) includes generating a report that identifies a root cause of at least one test failure, generating proposed change(s) to a test script for the automated testing, and/or generating proposed change(s) to source code for the product under test.

### BACKGROUND

Quality Assurance teams regularly use automated testing to verify whether given functionality in a software product is working properly. The teams may write a large number of automated test scripts that may be run a number of times throughout the day, and logs (e.g., test logs and product logs) may be generated during the automated testing to capture information related to the automated testing. Test logs may be generated during automated testing and may include a report of the executed tests, error messages, outcomes of the tests, and other relevant information regarding the automated testing. Product logs may also be generated during automated testing and may include detailed records of events and actions that occur within a product during the automated testing. For example, the product logs may comprise a record of product level errors, warnings, and other relevant information regarding the operations of the product during the automated testing.

### SUMMARY

Embodiments of the present disclosure relate to root cause failure identification using multi-stage retrieval-augmented generation. Systems and methods are disclosed that may be used for, among other things, identifying root causes of test failures during automated testing and performing operations to address the identified root causes of the test failures.

In contrast to conventional systems, the systems and methods presented in this disclosure may use a multi-stage retrieval-augmented generation system to improve the analysis of test log(s) and product log(s) generated during automated testing to find a root cause of test failures during the automated testing. The multi-stage retrieval-augmented generation system may include first model(s) that may extract a first context from test log(s) including a test failure based on first prompt(s) and information retrieved from first database(s). The first prompt(s) may provide a role for the first model(s) to perform in order to analyze the test log(s) and extract the first context based on the information retrieved from the first database(s). The multi-stage retrieval-augmented generation system may also include second model(s) that may extract a second context from product log(s) corresponding to the test log(s) based on the first context extracted from the test log(s), second prompt(s), and information retrieved from second database(s). The second prompt(s) may provide a role for the second model(s) to perform in order to analyze the product log(s) and extract the second context based on the first context from the test log(s) and information retrieved from the second database(s). One or more operations for addressing the test failure may be performed based on the second context extracted from the product log(s). For example, the operation(s) may include generating a report that identifies a root cause of at least one test failure, generating one or more proposed changes to a test script for the automated testing, and/or generating one or more proposed changes to source code for the product under test. The multi-stage analysis approach may reduce the time and/or computing resources required to identify the root cause of failure and increase the accuracy of identification of root cause(s) for automated test failure(s) and also reduce the likelihood of false positives or misidentification.

### BRIEF DESCRIPTION OF THE DRAWINGS

The present systems and methods for root cause failure identification using multi-stage retrieval-augmented generation are described in detail below with reference to the attached drawing figures, wherein:

FIG. 1A is an illustration of an example data flow diagram for a root cause analysis operating environment suitable for use in implementing some embodiments of the present disclosure;

FIG. 1B is an illustration of an example data flow diagram for a root cause analysis operating environment suitable for use in implementing some embodiments of the present disclosure;

FIG. 2 is an illustration of a flow diagram for an example vector database generation system suitable for use in implementing some embodiments of the present disclosure;

FIG. 3 is an illustration of an example flow diagram for addressing root cause failures for automated testing, in accordance with some embodiments of the present disclosure;

FIG. 4 is an illustration of an example flow diagram for addressing root cause failures for automated testing, in accordance with some embodiments of the present disclosure;

FIG. 5A is a block diagram of an example generative language model system suitable for use in implementing at least some embodiments of the present disclosure;

FIG. 5B is a block diagram of an example generative language model that includes a transformer encoder-decoder suitable for use in implementing at least some embodiments of the present disclosure;

FIG. 5C is a block diagram of an example generative language model that includes a decoder-only transformer architecture suitable for use in implementing at least some embodiments of the present disclosure;

FIG. 6 is a block diagram of an example computing device suitable for use in implementing at least some embodiments of the present disclosure; and

FIG. 7 is a block diagram of an example data center suitable for use in implementing at least some embodiments of the present disclosure.

### DETAILED DESCRIPTION

Systems and methods are disclosed related to root cause failure identification using multi-stage retrieval-augmented generation. Quality Assurance teams may review the test logs for test failures, which may occur for a variety of reasons (e.g., test environment, a bug in the software product under test, an error in the test script, etc.). The test logs are analyzed when automated tests fail to identify the root cause of the test failure. Traditional methods of analyzing automated testing failures often rely on manual review of the test logs or relatively simplistic automated approaches. Many of these methods also rely only on the test logs generated from the automated tests, which often do not contain the actual product failure(s).

In contrast to conventional systems, such as those described above, the systems and methods presented in this disclosure use a multi-stage retrieval-augmented generation system to improve the analysis of test log(s) and product log(s) generated during automated testing to find a root cause of test failures during the automated testing. The multi-stage retrieval-augmented generation system may include one or more first models that may extract a first context from test log(s) including a test failure based on first prompt(s) and information retrieved from one or more first databases (e.g., vector database(s)). The first prompt(s) may provide a role for the first model(s) to perform in order to analyze the test log(s) and extract the first context based on the information retrieved from the first database(s). The multi-stage retrieval-augmented generation system may also include one or more second models that may extract a second context from product log(s) corresponding to the test log(s) based on the first context from the test log(s), second prompt(s), and information retrieved from one or more second databases (e.g., vector database(s)). The second prompt(s) may provide a role for the second model(s) to perform in order to analyze the product log(s) and extract the second context based on the first context from the test log(s) and information retrieved from the second database(s). One or more operations for addressing the test failure may be performed based on the second context extracted from the product log(s). For example, the operation(s) may include generating a report that identifies a root cause of at least one test failure, generating one or more proposed changes to a test script for the automated testing, and/or generating one or more proposed changes to source code for the product under test. The multi-stage analysis approach may reduce the time and/or computing resources required to identify the root cause of failure, which may enable faster resolution and reduced downtime. Further, the more targeted analysis of the product log(s) based on the context extracted from the test log(s) may increase the accuracy of identification of root cause(s) for automated test failure(s) and also reduce the likelihood of false positives or misidentification. Moreover, the systems and methods may provide a more comprehensive understanding of the automated test failure based on the multi-stage analysis may enable more effective troubleshooting and debugging.

The first stage of the multi-stage analysis approach may include using first model(s) to extract a first context from the test log(s) based on first prompt(s) and information retrieved from one or more first databases (e.g., a vector database). The first model(s) may comprise one or more neural networks that generate an output indicative of the first context extracted from the test log(s) based on the first prompt(s) and information retrieved from the first database(s). For example, the neural network(s) may comprise a first retrieval-augmented generative model (e.g., a Large Language Model (LLM) Retrieval-Augmented Generation (RAG) model or a Small Language Model (SLM) RAG model).

The first prompt(s) provided to the first model(s) may include a predetermined system prompt describing a role for the first model(s). For example, the predetermined system prompt may assign a role of an automation engineer to the first model(s) and tasks to perform for extracting the first context from the test log(s). The first prompt(s) may also include additional textual information provided, for example, by a user and/or a machine learning model to request additional information and/or provide additional context for the analysis of the test log(s). The information retrieved from the first database(s) may comprise relevant test log data from historical test logs that have been generated during automated testing that is similar to the test log(s) input to the first model(s).

The first database(s) may be generated (updated, etc.) prior to operation of the multi-stage retrieval-augmented generation system, and the first database(s) may comprise vector embeddings generated based on input data corresponding to historical test logs that have been generated during automated testing. The input data corresponding to historical test logs that have been generated during automated testing may include textual information from historical test logs of past automated tests. In some embodiments, the input data corresponding to historical test logs that have been generated during automated testing may also include one or more images (e.g., screenshot(s)) captured during the automated testing that generated the historical test logs. The vector embeddings may be generated from the input data corresponding to the historical test logs using one or more embedding models. The input data may be preprocessed to remove irrelevant (e.g., to the analysis by the first model(s)) information, normalize the test log data, chunk the test log data, and/or tokenize the test log data. The vector embedding(s) to be stored in the first database(s) may be generated from the (preprocessed) historical test logs using the embedding model(s). The vector embeddings may capture both the syntax and the semantics of the historical test logs represented by the input data. The embedding model(s) may be unimodal (e.g., text) or multi-modal (e.g., text and images) depending on the desired implementation. In examples where the embedding model(s) are unimodal, one or more vision language models (VLMs) may be used to generate textual information that analyzes or summarizes the image(s) (e.g., screenshots) provided as input data corresponding to the historical test logs, and this generated textual information may be provided to the embedding model(s) to generate vector embeddings.

The first model(s) may retrieve information that is relevant to the test log(s) input to the first model(s) from the first database(s) using one or more first retrievers. The first retriever(s) may identify information from the first database(s) that is relevant to the test log(s) input to the first models based on a similarity between the embeddings generated from the test log(s) and the vector embeddings stored in the first database(s). In some embodiments, the first model(s) may retrieve information from the first database(s) using a first retrieval ensemble that includes a first syntactic retriever (e.g., a BM25 retriever) and a first semantic retriever. The first syntactic retriever may perform retrieval based on keyword matching or other techniques, and the first semantic retriever may perform retrieval based on dense semantic searching or other techniques. The first semantic retriever may be weighted higher than the first syntactic retriever for the first retrieval ensemble, which may enable better performance of the first model(s) when analyzing test logs having multiple formats or structures. The information retrieved from the first database(s) may be provided as additional input to the first model(s) for generating the output indicative of the first context extracted from the test log(s) input to the first model(s).

Using the first prompt(s) and the information retrieved from the first database(s), the first model(s) may analyze and extract a first context from the test log(s) input to the first model(s), which may include patterns and anomalies that are indicative of the test failure. The first context may comprise a root cause of the test failure in the test log(s), step(s) that led to the test failure, and/or test metadata. The first model(s) may generate an output indicative of the first context, which may be provided as input for the second stage of the multi-stage retrieval-augmented generation system that is discussed below. In some embodiments, the output indicative of the first context may be provided in a JavaScript Object Notation (JSON) format. It should be understood that other formats may also be used for the output indicative of the first context depending on the desired operation of the multi-stage retrieval-augmented generation system.

The second stage of the multi-stage analysis approach may include using second model(s) to extract a second context from product log(s) based on the first context (e.g., output indicative of the first context), second prompt(s), and information retrieved from one or more second databases (e.g., a vector database). The second model(s) may comprise one or more neural networks that generate an output indicative of the second context extracted from the product log(s) based on the first context, the second prompt(s), and the information retrieved from the second database(s). For example, the neural network(s) may comprise a second retrieval-augmented generative model (e.g., a LLM RAG model or a SLM RAG model).

The second prompt(s) provided to the second model(s) may include a predetermined system prompt describing a role for the second model(s). For example, the predetermined system prompt may assign a role of a product developer to the second model(s) and tasks to perform for extracting the second context from the product log(s). The second prompt(s) may also include additional textual information provided, for example, by a user and/or a machine learning model to request additional information and/or provide additional context for the analysis of the product log(s). The information retrieved from the second database(s) may comprise relevant product log data from historical product logs that have been generated during automated testing that is similar to the product log(s) input to the second model(s).

The second database(s) may be generated (updated, etc.) prior to operation of the multi-stage retrieval-augmented generation system, and the second database(s) may comprise vector embeddings generated based on input data corresponding to historical product logs that have been generated during automated testing. The input data corresponding to historical product logs that have been generated during automated testing may include textual information from historical product logs. The vector embeddings may be generated from the input data corresponding to the historical product logs using one or more embedding models. The input data may be preprocessed to remove irrelevant (e.g., to the analysis by the second model(s)) information, normalize the product log data, chunk the product log data, and/or tokenize the product log data. The vector embedding(s) to be stored in the second database(s) may be generated from the (preprocessed) historical product logs using the embedding model(s). The vector embeddings may capture both the syntax and the semantics of the historical product logs represented by the input data that corresponds to historical product logs that have been generated during automated testing. The embedding model(s) used to generate the vector embeddings for the second database(s) may be unimodal (e.g., text).

The second model(s) may retrieve information that is relevant to the product log(s) input to the second model(s) from the second database(s) using one or more second retrievers. The second retriever(s) may identify information from the second database(s) that is relevant to the product log(s) input to the second models based on a similarity between the embeddings generated from the product log(s) and the vector embeddings stored in the second database(s). In some embodiments, the second model(s) may retrieve information from the second database(s) using a second retrieval ensemble that includes a second syntactic retriever (e.g., a BM25 retriever) and a second semantic retriever. The second syntactic retriever may perform retrieval based on keyword matching or other techniques, and the second semantic retriever may perform retrieval based on dense semantic searching or other techniques. The second syntactic retriever may be weighted higher than the second semantic retriever for the second retrieval ensemble, which may enable faster inference for the second model(s). The information retrieved from the second database(s) may be provided as additional input to the second model(s) for generating the output indicative of the second context extracted from the product log(s) input to the second model(s).

Using the first context, the second prompt(s), and the information retrieved from the second database(s), the second model(s) may analyze and extract a second context from the product log(s) input to the second model(s), which may include patterns and anomalies that are indicative of the test failure in the product. The second context may comprise error codes, identification of functionality in the product that failed, step(s) in the product log(s) that led to the test failure, and/or test metadata. The second model(s) may generate an output indicative of the second context. In some embodiments, the output indicative of the second context may be provided in a JSON format. It should be understood that other formats for the output indicative of the second context may also be used depending on the desired operation of the multi-stage retrieval-augmented generation system.

One or more operations for addressing the at least one test failure may be performed based on the output indicative of the second context extracted from the product log(s). The operation(s) may include generating a report that identifies a root cause of at least one test failure, which may be used by a user or another model to debug the source code of the product. In some embodiments, the output indicative of the second context extracted from the product log(s) may be displayed (e.g., to a user) in natural language. In some embodiments, the output indicative of the second context extracted from the product log(s) may be generated in natural language or may be converted from a JSON format to natural language.

In some embodiments, the one or more operations for addressing the at least one test failure may include a third stage that may include using third model(s) to identify portion(s) of source code for the product that are relevant to the test failure and generate proposed changes to source code for the product. The third model(s) may identify portion(s) of the source code that are relevant to the test failure and generate the proposed changes to the source code based on the second context (e.g., the output indicative of the second context), third prompt(s), and information retrieved from one or more third databases (e.g., vector database(s)). The third model(s) may comprise one or more code generation neural networks that generate proposed changes to the source code for the product based on the second context, the third prompt(s), and the information retrieved from the third database(s). For example, the code generation neural network(s) may comprise a third retrieval-augmented generative model (e.g., a LLM RAG model or a SLM RAG model). In some embodiments, the third retrieval-augmented generative model may be specifically tailored to code generation.

The third prompt(s) provided to the third model(s) may include a predetermined system prompt describing a role for the third model(s). For example, the predetermined system prompt may assign a role of a product developer to the third model(s) and tasks to perform for generating proposed changes to the source code for the product to address the failure(s) in the second context. The third prompt(s) may also include additional textual information provided, for example, by a user and/or a machine learning model to request additional information and/or provide additional context for the generation of the proposed changes to the source code of the product. The information retrieved from the third database(s) may comprise portions of the source code for the product identified as being relevant to the failure(s) in the second context.

The third database(s) may be generated (updated, etc.) prior to operation of the multi-stage retrieval-augmented generation system, and the third database(s) may comprise vector embeddings generated based on input data corresponding to code for the product being tested. The vector embeddings may be generated from the input data corresponding to the code for the product being tested using one or more embedding models. In some embodiments, the input data corresponding to code for the product being tested may include code from one or more repositories. The input data may be preprocessed to remove irrelevant (e.g., to the analysis by the third model(s)) information, normalize the code, chunk the code, and/or tokenize the code. The vector embedding(s) to be stored in the third database(s) may be generated from the (preprocessed) code using the embedding model(s). The vector embeddings may capture the syntax and the semantics of the code represented by the input data. The embedding model(s) used to generate the vector embeddings for the third database(s) may be unimodal (e.g., text).

The third model(s) may retrieve information that is relevant to addressing the failure(s) in the product identified in the second context from the third database(s) using one or more third retrievers. The retriever(s) may identify information from the third database(s) that is relevant to addressing the failure(s) in the product identified in the second context based on a similarity between the embeddings generated from the source code and the vector embeddings stored in the third database(s). In some embodiments, the third model(s) may retrieve information from the third database(s) using a third retrieval ensemble that includes a third syntactic retriever and a code retriever. The third syntactic retriever may perform retrieval based on keyword matching or other techniques, and the code retriever may perform retrieval using one or more techniques specifically tailored for code retrieval. The information retrieved from the third database(s) may be provided as additional input to the third model(s) for generating the proposed changes to the source code for the product being tested.

Using the second context, the third prompt(s), and the information retrieved from the third database(s), the third model(s) may identify relevant portions of the source code for the product and generate one or more proposed changes to the source code for the product that will fix the test failure(s) included in the output indicative of the second context extracted from the product log(s). The proposed changes to the source code for the product being tested may be represented using a code difference output, which may comprise a copy of the previous version of the portion(s) of the source code and the proposed version of the portion(s) of the source code with the proposed changes to the source code. In some embodiments, the proposed changes to the source code may be highlighted or otherwise differentiated to enable easier review of the proposed changes to the source code. The proposed changes to the source code for the product may be output for display and review by a user. For example, a user may review the proposed changes and accept the proposed changes, reject the proposed changes, or modify the proposed changes.

While the third stage is described with respect to identifying portion(s) of the source code for the product and generating one or more proposed changes for the source code of the product, it should be understood that other implementations are possible. For example, a test failure may be caused by an error in the test script for the automated test rather than an error in the source code for the product. In some embodiments, the test script(s) for the automated test may be provided to the third model(s) in addition to, or instead of, the source code for the product. The third model(s) may identify relevant portions of the test script(s) and generate one or more proposed changes to the test script(s) based on the output indicative of the second context extracted from the product log(s), prompt(s) (e.g., a role prompt), and information retrieved from a database (e.g., a vector database with vector embeddings generated from input data corresponding to test scripts for automated testing).

Embodiments presented in the disclosure primarily refer to analysis of various logs, such as test log(s) and product log(s), to identify and address root causes of test failure(s) during automated testing. However, it should be understood that techniques similar to those described herein may be used for other applications. Further, while the databases used for retrieval are described herein as including vector embeddings, it should be understood that the databases may be used to store embeddings, encodings, or other complex representations of the input data that are suitable for retrieval in the manner described herein. Embodiments presented in this disclosure may be implemented in the analysis of corresponding data for any number of scenarios and may be used to generate reports, modifications, or the like for a variety of applications.

Although examples may be described herein with respect to using machine learning models, such as neural networks or diffusion models, this is not intended to be limiting. For example, and without limitation, any of the various machine learning models and/or neural networks described herein may include any type of machine learning model, such as a machine learning model(s) using linear regression, logistic regression, decision trees, support vector machines (SVM), Naïve Bayes, k-nearest neighbor (Knn), K means clustering, random forest, dimensionality reduction algorithms, gradient boosting algorithms, neural networks (e.g., auto-encoder neural networks, artificial neural networks (ANNs), convolutional neural networks (CNNs), recurrent neural networks (RNNs), perceptrons, Long/Short Term Memory (LSTM) networks, multi-layer perceptron (MLP) networks, deep stacking networks (DSNs), generative pre-training (GPT) models or networks, feed forward networks, radial basis function ANNs, self-organizing maps (SOMs), Kohonen maps, Hopfield networks, Boltzmann machine, deep belief neural networks, deconvolutional neural networks, generative adversarial networks (GANs), liquid state machines, modular neural networks, liquid state machines, sequence-to-sequence models, networks using transformer architectures, state space models (SSMs) (e.g., networks using Mamba architectures (e.g., Mamba-1, Mamba 2, etc.), networks using selective state space models, networks using structured state space sequence models, etc.), diffusion models (e.g., diffusion probabilistic models, score-based generative models, etc.), neural radiance field (NeRF) models, Gaussian splat models, Kolmogorov-Arnold networks (KANs), models with encoder-only architectures, models with decoder-only architectures, models with encoder-decoder architectures, generative machine learning models, language models, large language models (LLMs), small language models (SLMs), vision language models (VLMs), multi-modal language models (MMLMs), large action models (LAMs), etc.), and/or other types of machine learning models.

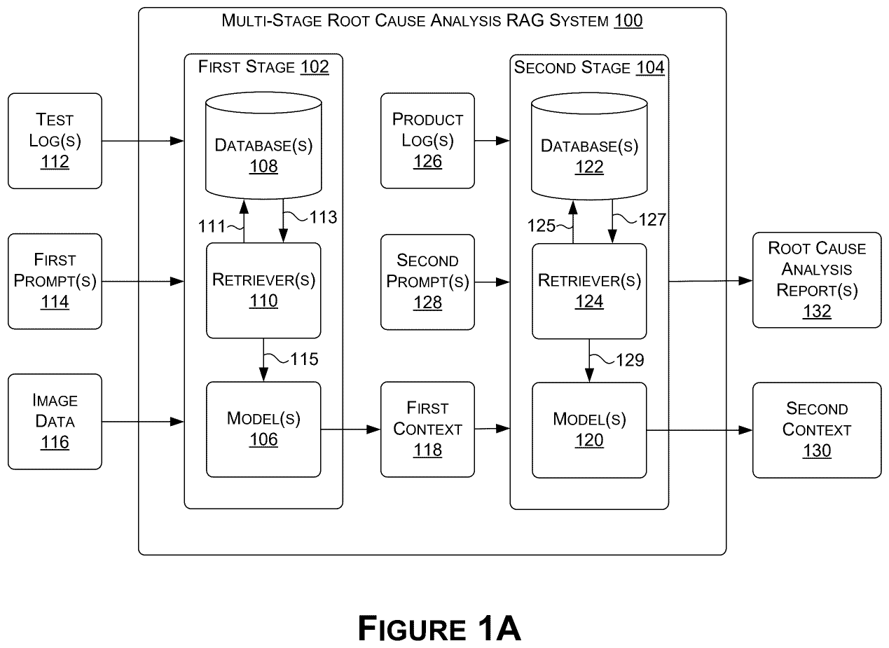

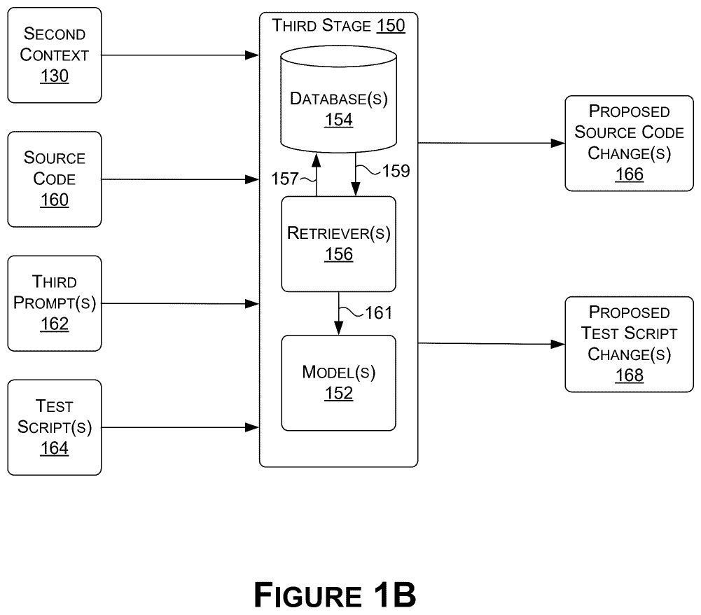

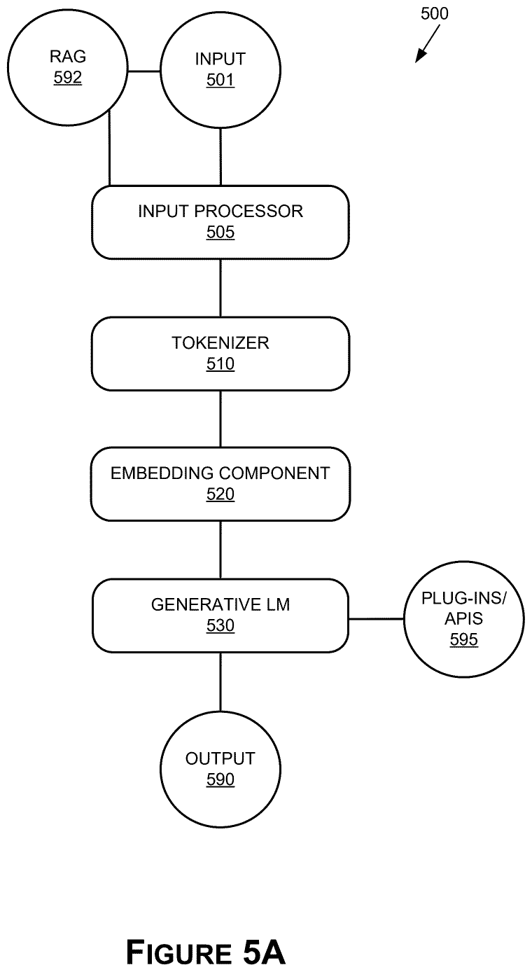

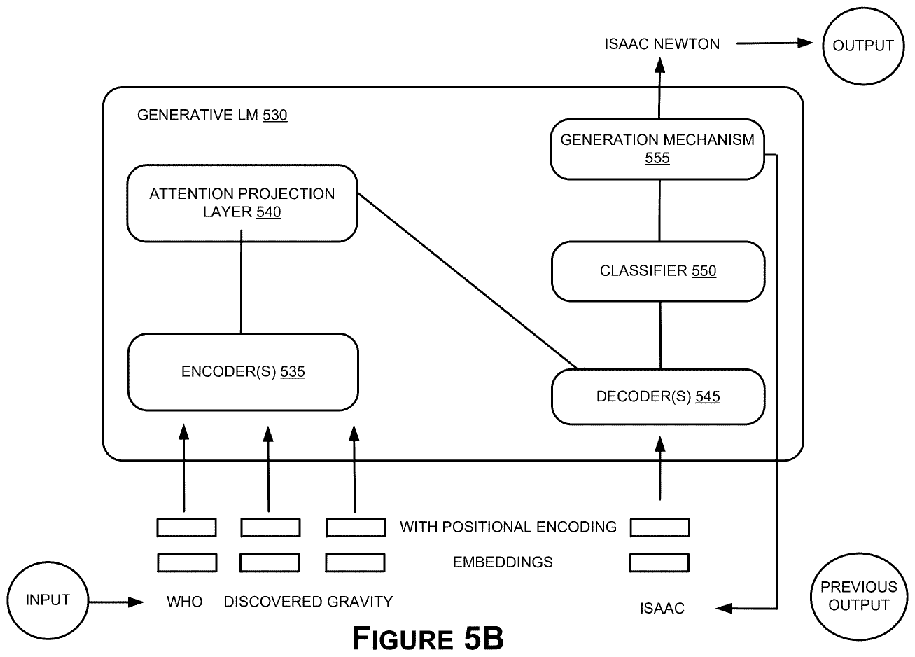

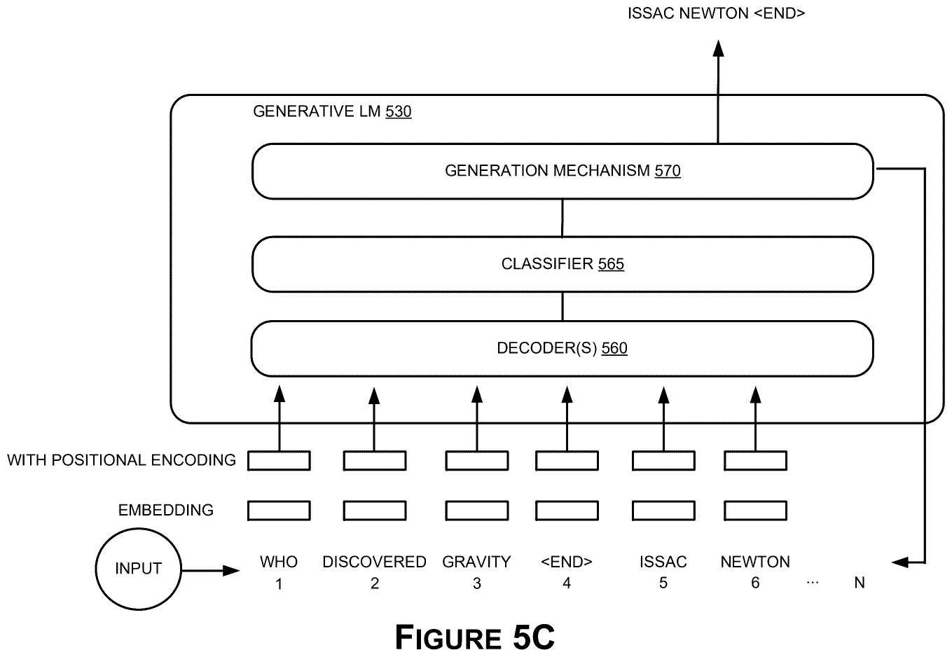

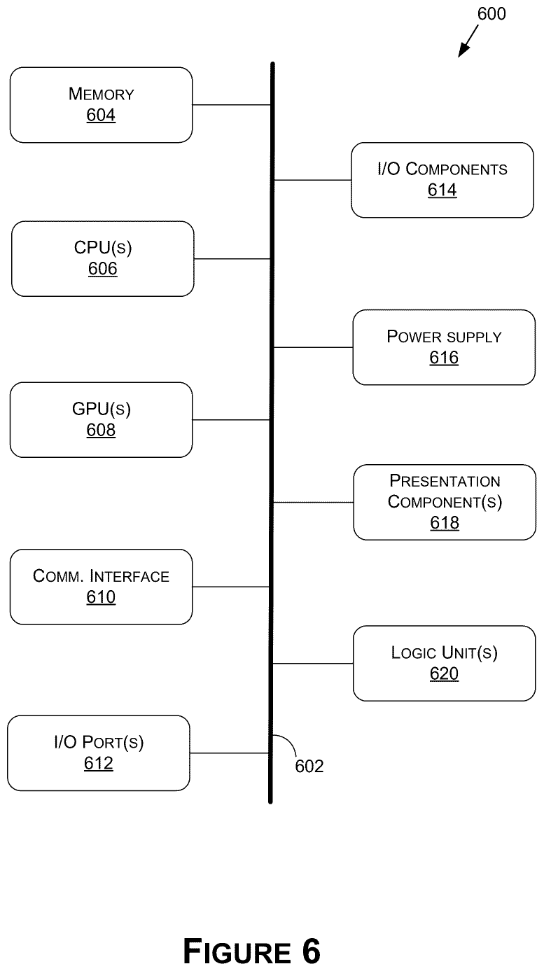

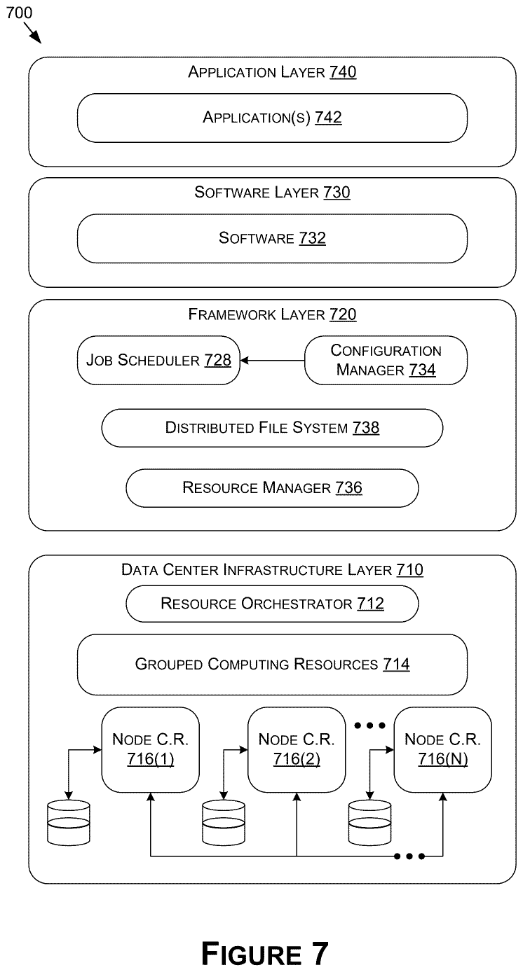

With reference to FIG. 1A, FIG. 1A is an example data flow diagram illustrating the interconnection of components and flow of information of data for an example multi-stage root cause analysis RAG system 100, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out using one or more processors executing instructions stored in one or more memories. For example, in some embodiments, the system and methods described herein may be implemented using one or more generative language models (e.g., as described in FIGS. 5A-5C), one or more computing devices or components thereof (e.g., as described in FIG. 6), and/or one or more data centers or components thereof (e.g., as described in FIG. 7).

In the example shown in FIG. 1A, the multi-stage root cause analysis RAG system 100 may include at least a first stage 102 and a second stage 104. The first stage 102 of the multi-stage root cause analysis RAG system 100 may include first model(s) 106, first database(s) 108, and first retriever(s) 110. The second stage 104 of the multi-stage root cause analysis RAG system 100 may include second model(s) 120, second database(s) 122, and second retriever(s) 124. The first stage 102 and the second stage 104 of the multi-stage root cause analysis RAG system 100 may be implemented as agents that utilize one or more machine learning models. For example, the first stage 102 and the second stage 104 of the multi-stage root cause analysis RAG system 100 may be implemented using language model(s) (LM(s)) (e.g., LLM(s) and/or SLM(s)) or other types of generative AI applications. In some embodiments, the first stage 102 and/or the second stage 104 of the multi-stage root cause analysis RAG system 100 may be implemented using one or more microservices.

The first stage 102 of the multi-stage root cause analysis RAG system 100 may receive inputs that may be provided, for example, by a user via a user interface (e.g., a web user interface). In the example shown in FIG. 1A, the first stage 102 may receive test log(s) 112 as input. The test log(s) 112 may be generated during automated testing that includes automated test scripts that are run throughout the day and capture information related to the automated testing. For example, the test log(s) 112 may include a report of the executed tests, error messages, outcomes of the tests, and other relevant information regarding the automated testing. The test log(s) 112 may be provided in a standard format or a non-standard format depending on the implementation.

In the example shown in FIG. 1A, the first stage 102 may also receive first prompt(s) 114 as input. The first prompt(s) 114 may include a predetermined system prompt describing a role for the first model(s) 106 of the first stage 102. For example, the predetermined system prompt may assign a role of an automation engineer to the first model(s) 106 and tasks to perform for extracting first context 118 from the test log(s) 112. The first prompt(s) 114 may also include additional contextual information provided, for example, by a user and/or a machine learning model to request additional information and/or provide additional context for the analysis of the test log(s) 112. The predetermined system prompts may be pre-populated in the user interface or automatically provided to the first stage 102, and a user may add the additional contextual information via the user interface prior to providing the input to the first stage 102 of the multi-stage root cause analysis RAG system 100.

In some embodiments, the first stage 102 of the multi-stage root cause analysis RAG system 100 may also receive image data 116 in addition to the test log(s) 112 and the first prompt(s) 114. The image data 116 may correspond to the test log(s) 112 and include, for example, screenshot(s) captured during the automated testing that also generated the test log(s) 112. In some embodiments, the first model(s) 106 may include one or more vision language models (VLMs) that may be used to generate textual information that analyzes or summarizes the image data 116 corresponding to the historical test logs. The image data 116 and/or the textual information generated from the image data 116 may be used by the first model(s) 106 in addition to the first prompt(s) 114 to generate the output indicative of the first context 118 extracted from the test log(s) 112.

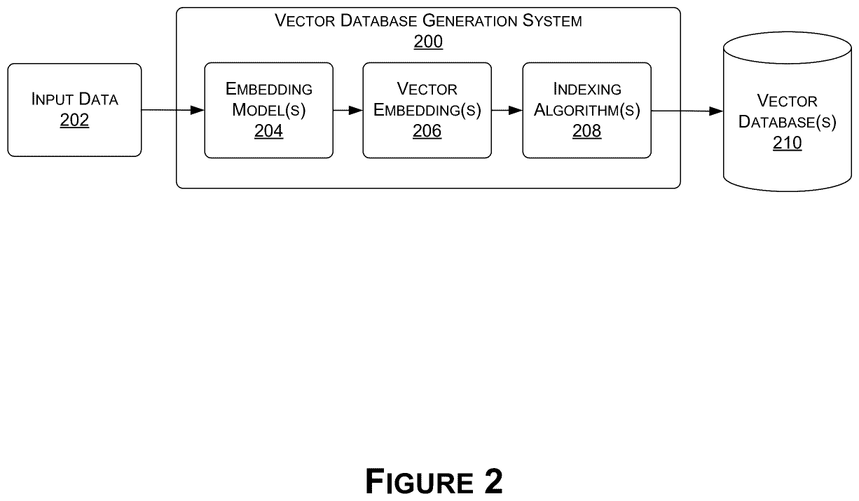

The first stage 102 of the multi-stage root cause analysis RAG system 100 may receive the test log(s) 112, the first prompt(s) 114, and the image data 116 (if applicable) and extract the first context 118 from the test log(s) 112 using the first model(s) 106. The first model(s) 106 may comprise one or more neural networks. For example, the first model(s) 106 may comprise a first retrieval-augmented generative model (e.g., a language model (LM) RAG model) that may generate an output indicative of the first context 118 extracted from the test log(s) 112 based on the first prompt(s) 114, image data 116 (if applicable), and information retrieved from the first database(s) 108. The first database(s) 108 may be generated (updated, etc.) prior to operation of the multi-stage root cause analysis RAG system 100. In some embodiments, the first database(s) 108 may comprise vector database(s) generated using the vector database generation system 200 shown in FIG. 2 and described in more detail below. The first database(s) 108 may comprise vector embeddings generated based on input data corresponding to historical test logs that have been generated during automated testing. The input data corresponding to historical test logs that have been generated during automated testing may include textual information from historical test logs of past automated tests. In some embodiments, the input data corresponding to historical test logs that have been generated during automated testing may also include one or more images (e.g., screenshot(s)) captured during the automated testing that generated the historical test logs. The vector embeddings may be generated from the input data corresponding to the historical test logs using embedding model(s). In some embodiments, the input data may be preprocessed to remove irrelevant (e.g., to the analysis by the first model(s) 106) information, normalize the test log data, chunk the test log data, and/or tokenize the test log data. The vector embedding(s) to be stored in the first database(s) 108 may be generated from the data corresponding to the historical test logs using the embedding model(s), and the vector embeddings may capture both the syntax and the semantics of the historical test logs represented by the input data.

The first model(s) 106 may retrieve information 113 that is relevant to the test log(s) 112 input to the first stage 102 from the first database(s) 108 using the first retriever(s) 110. The first retriever(s) 110 may identify information from the first database(s) 108 that is relevant to the test log(s) 112 based on a similarity between vector embedding(s) 111 generated from the test log(s) 112 (e.g., using embedding model(s)) and vector embeddings stored in the first database(s) 108. In some embodiments, the first retriever(s) 110 used by the first model(s) 106 to retrieve information 113 from the first database(s) 108 may include a first retrieval ensemble that includes a first syntactic retriever (e.g., a BM25 retriever) and a first semantic retriever. The first syntactic retriever may perform retrieval based on keyword matching or other techniques, and the first semantic retriever may perform retrieval based on dense semantic searching or other techniques. The first semantic retriever may be weighted higher than the first syntactic retriever for the first retrieval ensemble, which may enable better performance of the first model(s) 106 when analyzing test logs having multiple formats or structures. The information 113 retrieved from the first database(s) 108 may be provided as additional input 115 to the first model(s) 106 for generating the output indicative of the first context 118 extracted from the test log(s) 112 input to the first model(s) 106.

The additional input 115 to the first model(s) 106 that includes the information 113 retrieved from the first database(s) 108 may comprise relevant test log data from historical test logs that have been generated during automated testing that is similar to the test log(s) 112 input to the first stage 102. The first model(s) 106 may analyze and extract the first context 118 from the test log(s) 112 based on the first prompt(s) 114 and the additional input 115 that includes the information 113 retrieved from the first database(s) 108. The first context 118 extracted by the first model(s) 106 may include patterns and anomalies that are indicative of the test failure. For example, the first context 118 may comprise a root cause of the test failure in the test log(s) 112, step(s) in the test log(s) 112 that led to the test failure, and/or test metadata. The first model(s) 106 may generate an output indicative of the first context 118, which may be provided as input for the second stage 104 of the multi-stage root cause analysis RAG system 100 that is discussed below. In some embodiments, the output indicative of the first context 118 may be provided in a JSON format. It should be understood that other formats may also be used for the output indicative of the first context 118 depending on the desired operation of the multi-stage root cause analysis RAG system 100.

The second stage 104 of the multi-stage root cause analysis RAG system 100 may receive the first context 118 from the first stage 102 and other inputs that may be provided, for example, by a user via a user interface (e.g., a web user interface). In the example shown in FIG. 1A, the second stage 104 may receive product log(s) 126 as input. The product log(s) 126 may be generated during automated testing that includes automated test scripts being run throughout the day and capture information related to the automated testing for the product. For example, the product log(s) 126 may include records of event(s) and action(s) that occur within a product during the automated testing. The product log(s) 126 may be provided in a standard format or a non-standard format depending on the implementation.

In the example shown in FIG. 1A, the second stage 104 may also receive second prompt(s) 128 as input. The second prompt(s) 128 may include a predetermined system prompt describing a role for the second model(s) 120 of the second stage 104. For example, the predetermined system prompt may assign a role of a product developer to the second model(s) 120 and tasks to perform for extracting the second context 130 from the product log(s) 126. The second prompt(s) 128 may also include additional contextual information provided, for example, by a user and/or a machine learning model to request additional information and/or provide additional context for the analysis of the product log(s) 126. The predetermined system prompts may be pre-populated in the user interface or automatically provided to the second stage 104, and a user may add the additional contextual information via the user interface prior to providing the input to the second stage 104 of the multi-stage root cause analysis RAG system 100.

The second stage 104 of the multi-stage root cause analysis RAG system 100 may receive the first context 118, the product log(s) 126, and the second prompt(s) 128. The second stage 104 may extract a second context 130 from the product log(s) 126 using the second model(s) 120. The second model(s) 120 may comprise one or more neural networks. For example, the second model(s) 120 may comprise a second retrieval-augmented generative model (e.g., an LM RAG model) that may generate an output indicative of the second context 130 extracted from the product log(s) 126 based on the first context 118, the second prompt(s) 128, and information retrieved from the second database(s) 122. The second database(s) 122 may be generated (updated, etc.) prior to operation of the multi-stage root cause analysis RAG system 100. In some embodiments, the second database(s) 122 may comprise vector database(s) generated using the vector database generation system 200 shown in FIG. 2 and described in more detail below. The second database(s) 122 may comprise vector embeddings generated based on input data corresponding to historical product logs that have been generated during automated testing. The input data corresponding to historical product logs that have been generated during automated testing may include textual information from historical product logs of past automated tests. In some embodiments, the input data may be preprocessed to remove irrelevant (e.g., to the analysis by the second model(s) 120) information, normalize the product log data, chunk the product log data, and/or tokenize the product log data. The vector embedding(s) may be generated from the input data corresponding to the historical product logs using embedding model(s), and the vector embeddings may capture both the syntax and the semantics of the historical product logs represented by the input data.

The second model(s) 120 may retrieve information 127 that is relevant to the product log(s) 126 input to the second stage 104 from the second database(s) 122 using the second retriever(s) 124. The second retriever(s) 124 may identify information from the second database(s) 122 that is relevant to the product log(s) 126 input to the product log(s) 126 based on a similarity between vector embedding(s) 125 generated from the product log(s) 126 (e.g., using embedding model(s)) and vector embeddings stored in the second database(s) 122. In some embodiments, the second retriever(s) 124 used by the second model(s) 120 to retrieve information 127 from the second database(s) 122 may include a second retrieval ensemble that includes a second syntactic retriever (e.g., a BM25 retriever) and a second semantic retriever. The second syntactic retriever may perform retrieval based on keyword matching or other techniques, and the second semantic retriever may perform retrieval based on dense semantic searching or other techniques. The second syntactic retriever may be weighted higher than the second semantic retriever for the second retrieval ensemble, which may enable faster inference for the second model(s) 120 when analyzing the product log(s) 126. The information 127 retrieved from the second database(s) 122 may be provided as additional input 129 to the second model(s) 120 for generating the output indicative of the second context 130 extracted from the product log(s) 126 input to the second model(s) 120.

The additional input 129 to the second model(s) 120 that includes the information 127 retrieved from the second database(s) 122 may comprise relevant product log data from historical product logs that have been generated during automated testing that is similar to the product log(s) 126 input to the second stage 104. The second model(s) 120 may analyze and extract the second context 130 from the product log(s) 126 based on the first context 118, the second prompt(s) 128, and the additional input 129 that includes the information 127 retrieved from the second database(s) 122. The second context 130 extracted by the second model(s) 120 may include patterns and anomalies in the product log(s) 126 that are indicative of the test failure in the product. For example, the second context 130 may comprise error codes, identification of functionality in the product that failed, step(s) in the product log(s) 126 that led to the test failure, and/or test metadata. The second model(s) 120 may generate an output indicative of the second context 130 in a JSON format or natural language. In some embodiments, the output indicative of the second context 130 extracted from the product log(s) 126 may be displayed (e.g., to a user) in natural language. In some embodiments, the output indicative of the second context 130 extracted from the product log(s) 126 may be generated in natural language or may be converted from a JSON format to natural language. It should be understood that other formats may also be used for the output indicative of the second context 130 depending on the desired operation of the multi-stage root cause analysis RAG system 100.

In some embodiments, the second stage 104 may perform one or more operations for addressing the at least one test failure based on the output indicative of the second context 130 extracted from the product log(s) 126. The operation(s) may include generating root cause analysis report(s) 132 that may identify a root cause of at least one test failure, which may be provided to a user or another model to debug the source code of the product. The root cause analysis report(s) 132 may be output in a format for submitting a bug to a developer for the product under testing and include information relevant to debugging the at least one test failure. For example, the root cause analysis report(s) 132 may include information related to the environment, steps to reproduce the test failure(s), expected result(s), actual result(s), screenshot(s), and/or other information that may be helpful for debugging. In some embodiments, the operation(s) may include providing the output indicative of the second context 130 to the optional third stage 150 of the multi-stage root cause analysis RAG system 100 that is discussed below.

With reference to FIG. 1B, FIG. 1B is an example data flow diagram illustrating the interconnection of components and flow of information of data for an example third stage 150 of the multi-stage root cause analysis RAG system 100, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out using one or more processors executing instructions stored in one or more memories. For example, in some embodiments, the system and methods described herein may be implemented using one or more generative language models (e.g., as described in FIGS. 5A-5C), one or more computing devices or components thereof (e.g., as described in FIG. 6), and/or one or more data centers or components thereof (e.g., as described in FIG. 7).

In some embodiments, the multi-stage root cause analysis RAG system 100 shown in FIG. 1A may also include the third stage 150 shown in FIG. 1B. The third stage 150 of the multi-stage root cause analysis RAG system 100 may receive the second context 130 from the second stage 104 and other inputs, which may be provided by a user or retrieved from a data store (e.g., repository). In the example shown in FIG. 1B, the third stage 150 may receive source code 160 and/or test script(s) 164 as input. The source code 160 may correspond to the source code for the product being tested using automated testing. For example, the source code 160 may include a subset of the code for the product that is specific to the functionality being tested using test script(s) 164 executed during the automated testing. The test script(s) 164 may correspond to the tests executed that generated the test log(s) 112 and the product log(s) 126. The test script(s) 164 may include instructions that may be executed to simulate interactions with the product under testing, compare the results of the execution with expected outcomes, and report the status of the test when executed (e.g., in the test log(s) 112).

In the example shown in FIG. 1B, the third stage 150 may also receive third prompt(s) 162 as input. The third prompt(s) 162 may include a predetermined system prompt describing a role for the third model(s) 152 of the third stage 150. For example, the predetermined system prompt may assign a role of a product developer to the third model(s) 152 and tasks to perform for generating proposed source code change(s) 166 and/or generating proposed test script change(s) 168. The third prompt(s) 162 may also include additional contextual information provided, for example, by a user and/or a machine learning model to request additional information and/or provide additional context for the generation of the proposed source code change(s) 166 and/or the proposed test script change(s) 168. The predetermined system prompts may be pre-populated in the user interface or automatically provided to the third stage 150, and a user may add the additional contextual information via the user interface prior to providing the input to the third stage 150 of the multi-stage root cause analysis RAG system 100.

The third stage 150 of the multi-stage root cause analysis RAG system 100 may receive the second context 130 and the third prompt(s) 162 as well as the source code 160 and/or the test script(s) 164. The third model(s) 152 of the third stage 150 may comprise one or more code generation neural networks (e.g., a third retrieval-augmented generative model (e.g., an LM RAG model)) that are specifically trained for code generation. The third model(s) may identify portion(s) of the source code 160 and/or the test script(s) 164 that are relevant to the test failure and generate proposed source code change(s) 166 and/or proposed test script change(s) 168 based on the second context 130, the third prompt(s) 162, and information retrieved from the third database(s) 154.

The third database(s) 154 may be generated (updated, etc.) prior to operation of the multi-stage root cause analysis RAG system 100. In some embodiments, the third database(s) 154 may comprise vector database(s) generated using the vector database generation system 200 shown in FIG. 2 and described in more detail below. The third database(s) 154 may comprise vector embeddings generated based on input data corresponding to code for the product being tested using the automated testing. The input data corresponding to code for the product being tested may include code from one or more repositories. In some embodiments, the input data may be preprocessed to remove irrelevant (e.g., to the analysis by the third model(s) 152) information, normalize the code, chunk the code, and/or tokenize the code. The vector embedding(s) may be generated from the input data corresponding to the code using embedding model(s), and the vector embeddings may capture both the syntax and the semantics of the code represented by the input data.

The third model(s) 152 may retrieve information 159 that is relevant to the source code 160 and/or the test script(s) 164 input to the third stage 150 from the third database(s) 154 using the third retriever(s) 156. The third retriever(s) 156 may identify information from the third database(s) 154 that is relevant to the source code 160 and/or the test script(s) 164 input to the third stage 150 based on a similarity between vector embedding(s) 157 generated from the source code 160 and/or the test script(s) 164 (e.g., using embedding model(s)) and vector embeddings stored in the third database(s) 154. In some embodiments, the third retriever(s) 156 used by the third model(s) 152 to retrieve information 159 from the third database(s) 154 may include a third retrieval ensemble that includes a third syntactic retriever and a code retriever. The third syntactic retriever may perform retrieval based on keyword matching or other techniques, and the code retriever may perform retrieval using one or more techniques specifically tailored for code retrieval. The information 159 retrieved from the third database(s) 154 may be provided as additional input 161 to the third model(s) 152 for identifying portion(s) of the source code 160 and/or test script(s) 164 that are relevant to the test failure(s) in the second context 130 and generating the proposed source code change(s) 166 and/or the proposed test script change(s) 168. The additional input 161 to the third model(s) 152 that includes the information 159 retrieved from the third database(s) 154 may comprise portion(s) of historical source code for the product and/or portion(s) of test scripts that are similar to the source code 160 and/or test script(s) 164 that are associated with the test failure(s) in the second context 130.

Based on the second context 130, the third prompt(s) 162, and the additional input 161 that includes the information 159 retrieved from the third database(s) 154, the third model(s) 152 may identify relevant portion(s) of the source code 160 for the product and generate proposed source code change(s) 166 that will fix the test failure(s) included in the output indicative of the second context 130 extracted from the product log(s) 126. The proposed source code change(s) 166 for the product being tested may be represented using a code difference output, which may comprise a copy of the previous version of the portion(s) of the source code 160 and the proposed version of the portion(s) of the source code with the proposed source code change(s) 166. In some embodiments, the proposed source code change(s) 166 may be highlighted or otherwise differentiated to enable easier review of the proposed source code change(s) 166. The proposed source code change(s) 166 for the product may be output for display and review by a user. For example, a user may review the proposed source code change(s) 166 and accept the proposed change(s), reject the proposed change(s), or modify the proposed change(s).

Based on the second context 130, the third prompt(s) 162, and the additional input 161 that includes the information 159 retrieved from the third database(s) 154, the third model(s) 152 may identify relevant portions of the test script(s) 164 for the automated testing and generate proposed test script change(s) 168 that will fix the test failure(s) included in the output indicative of the second context 130 extracted from the product log(s) 126. The proposed test script change(s) 168 for the automated testing may be represented using a difference output, which may comprise a copy of the previous version of the portion(s) of the test script(s) 164 and the proposed version of the portion(s) of the test scripts with the proposed test script change(s) 168. In some embodiments, the proposed test script change(s) 168 may be highlighted or otherwise differentiated to enable easier review of the proposed test script change(s) 168. The proposed test script change(s) 168 may be output for display and review by a user. For example, a user may review the proposed test script change(s) 168 and accept the proposed change(s), reject the proposed change(s), or modify the proposed change(s).

FIG. 2 is an example data flow diagram illustrating the interconnection of components and flow of information of data for a vector database generation system 200, in accordance with some embodiments of the present disclosure. As shown in FIG. 2, the vector database generation system 200 may include embedding model(s) 204 that generate vector embedding(s) 206 and indexing algorithm(s) 208 that store the vector embedding(s) 206 in vector database(s) 210. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

The vector database generation system 200 may receive input data 202, and the vector database generation system 200 may generate (update, etc.) the vector database(s) 210 based on the input data 202. The vector database generation system 200 may retrieve the input data 202 from a data store and/or receive the input data 202 (e.g., via a user interface). The input data 202 may include data corresponding to historical test logs that have been generated during automated testing, which may include textual information from historical test logs of past automated tests and/or one or more images (e.g., screenshot(s)) captured during the automated testing that generated the historical test logs. The input data 202 may include data corresponding to historical product logs that have been generated during automated testing, which may include textual information from historical product logs. The input data 202 may include data corresponding to code for the product being tested may include various portions of code for the product. The input data 202 may be preprocessed to remove irrelevant (e.g., to the analysis by the model(s) of the multi-stage root cause analysis RAG system 100) information, normalize the input data 202, chunk the input data 202, and/or tokenize the input data 202.

The vector database generation system 200 may include embedding model(s) 204 that may generate the vector embedding(s) 206 corresponding to the input data 202 input to the vector database generation system 200. The embedding model(s) 204 of the vector database generation system 200 may comprise one or more machine learning models (e.g., self-supervised auto-encoder(s)). The embedding model(s) 204 may be unimodal (e.g., text) or multi-modal (e.g., text and images) depending on the desired implementation. In examples where the embedding model(s) 204 are unimodal, one or more vision language models (VLMs) may be used to generate textual information that analyzes or summarizes the image(s) (e.g., screenshots) provided as input data 202 (e.g., corresponding to the historical test logs), and this generated textual information may be provided to the embedding model(s) 204 to generate the vector embedding(s) 206. The vector embedding(s) 206 may comprise embeddings, vectors, encodings, or other complex representations that are suitable for use in the manner described herein.

The vector embedding(s) 206 may be stored in the vector database(s) 210 using indexing algorithm(s) 208. In some embodiments, metadata corresponding to the vector embedding(s) 206 and the input data 202 used to generate the vector embedding(s) 206 may also be stored with the vector embedding(s) 206. The indexing algorithm(s) 208 may be used to index the vector embedding(s) 206 in order to map the vector embedding(s) 206 to a data structure. The indexing algorithm(s) 208 may be implemented, for example, using an algorithm such as Product Quantization (PQ), Locality-Sensitive Hashing (LSH), Hierarchical Navigable Small World (HNSW) or another type of indexing algorithm. The metadata corresponding to a particular vector embedding of the vector embedding(s) 206 may include, but is not limited to, a unique identifier for the vector embedding, a category of the input data 202, and/or other information about the input data 202. Once the vector embedding(s) 206 are stored in the vector database(s) 210, the vector embedding(s) 206 may not be modified. In some embodiments, the vector database(s) 210 may include one or more respective databases for each type of input data 202 (e.g., test log data, product log data, code, etc.), for example, as shown in FIGS. 1A-1B. The vector database(s) 210 may be generated (updated, etc.) prior to operation of the multi-stage root cause analysis RAG system 100 and the vector embedding(s) 206 may be retrieved from the vector database(s) 210 using retriever(s) of the multi-stage root cause analysis RAG system 100.

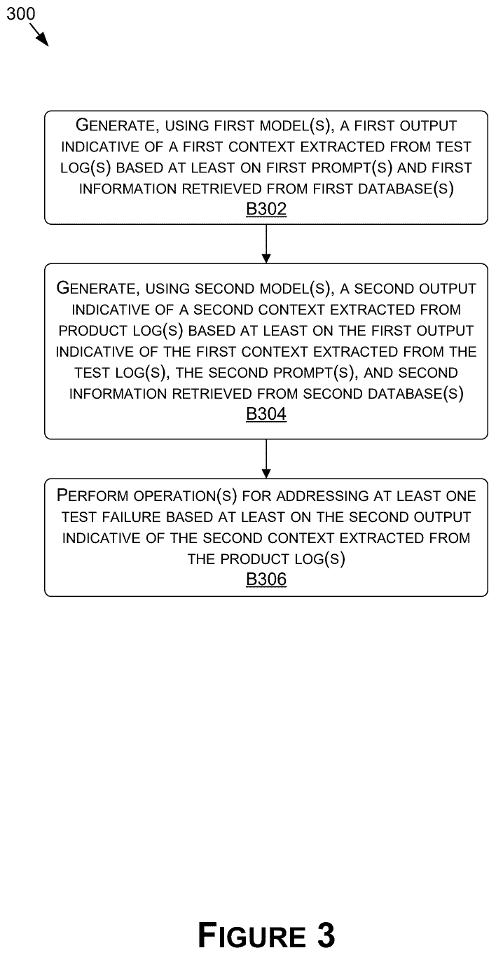

Now referring to FIG. 3, FIG. 3 is a flow diagram showing an example method 300 for addressing root cause failures for automated testing, in accordance with some embodiments of the present disclosure. Each block of method 300, described herein, comprises a computing process that may be performed using any combination of hardware, firmware, and/or software. For instance, various functions may be carried out by a processor executing instructions stored in memory. The method may also be embodied as computer-usable instructions stored on computer storage media. The method may be provided by a standalone application, a service or hosted service (standalone or in combination with another hosted service), or a plug-in to another product, to name a few. In addition, method 300 is described, by way of example, with respect to the system of FIGS. 1A-2. However, this method may additionally or alternatively be executed by any one system, or any combination of systems, including, but not limited to, those described herein.

The method 300, at block B302, includes generating, using one or more first models, a first output indicative of a first context extracted from one or more test logs based at least on one or more first prompts and first information retrieved from one or more first databases. The test log(s) may be generated during automated testing for a product and include a record of automated test execution for one or more tests conducted for the product. The test log(s) may also include at least one test failure that occurred during the automated testing for the product, which may be a result of the test environment, a bug in the product under testing, an error in the test scripts for the automated testing, and/or other factors. In some embodiments, image(s) (e.g., screenshot(s)) captured during automated testing and corresponding to the test log(s) may also be provided to the first model(s) and used to extract the first context from the test log(s).

The first model(s) may comprise one or more neural networks (e.g., a LM RAG model) that generate an output indicative of the first context extracted from the test log(s) based on the first prompt(s) and information retrieved from the first database(s). The first prompt(s) may include a predetermined system prompt describing a role for the first model(s). For example, the predetermined system prompt may assign a role of an automation engineer to the first model(s) and tasks to perform for extracting the first context from the test log(s). The first model(s) may retrieve the first information that is relevant to the test log(s) from first database(s) using first retriever(s), which may comprise a first retrieval ensemble that includes a first syntactic retriever (e.g., a BM25 retriever) and a first semantic retriever. The first retriever(s) may identify information from the first database(s) that is relevant to the test log(s) based on a similarity between vector embeddings generated from the test log(s) and vector embeddings stored in the first database(s). Using the first prompt(s) and the information retrieved from the first database(s), the first model(s) may analyze and extract a first context from the test log(s), which may include, but is not limited to, a root cause of the test failure in the test log(s), step(s) that led to the test failure, and/or test metadata. In some embodiments, the first output indicative of the first context may be provided in a JSON format. It should be understood that other formats for the first output indicative of the first context may also be used depending on the desired operation of the system.

The method 300, at block B304, includes generating, using second model(s), a second output indicative of a second context extracted from one or more product logs based at least on the first output indicative of the first context extracted from the test log(s), second prompt(s), and second information retrieved from one or more second databases. The product log(s) correspond to the test log(s) and may be generated during automated testing for a product and include a record of event(s) and action(s) that occur within a product during the automated testing. For example, the product log(s) may comprise a record of product level errors, warnings, and other relevant information regarding the operations of the product during the automated testing.

The second model(s) may comprise one or more neural networks (e.g., a LM RAG model) that generate an output indicative of the second context extracted from the product log(s) based on the first context, the second prompt(s), and information retrieved from the second database(s). The second prompt(s) may include a predetermined system prompt describing a role for the second model(s). For example, the predetermined system prompt may assign a role of a product developer to the second model(s) and tasks to perform for extracting the second context from the product log(s). The second model(s) may retrieve the second information that is relevant to the product log(s) from second database(s) using second retriever(s), which may comprise a second retrieval ensemble that includes a second syntactic retriever (e.g., a BM25 retriever) and a second semantic retriever. The second retriever(s) may identify information from the second database(s) that is relevant to the product log(s) based on a similarity between vector embeddings generated from the product log(s) and vector embeddings stored in the second database(s). Using the first context, the second prompt(s), and the information retrieved from the second database(s), the second model(s) may analyze and extract a second context from the product log(s), which may include, but is not limited to, error codes, identification of functionality in the product that failed, step(s) in the products log(s) that led to the test failure, and/or test metadata. In some embodiments, the second output indicative of the second context extracted from the product log(s) may be displayed (e.g., to a user) in natural language. The second output indicative of the second context extracted from the product log(s) may be generated in natural language or may be converted from a JSON format to natural language. It should be understood that other formats for the second output indicative of the second context may also be used depending on the desired operation of the system.

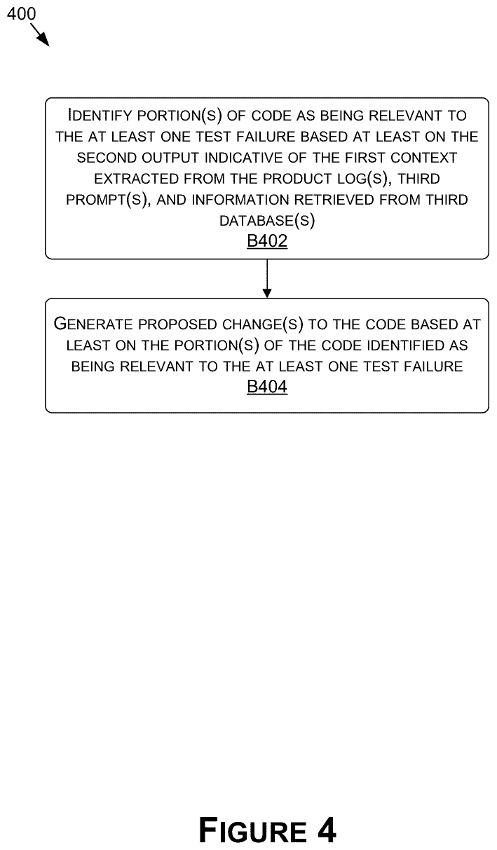

The method 300, at block B306, includes performing one or more operations for addressing at least one test failure based at least on the second output indicative of the second context extracted from the product log(s). In some embodiments, the operation(s) for addressing the at least one test failure may include generating one or more reports that identify a root cause of at least one test failure, which may be used by a user or another model to debug the source code of the product. The report may, for example, summarize the root cause analysis performed by the second model(s) to provide further information regarding the second context extracted from the product log(s). The reports may be output in a format for submitting a bug to a developer for the product under testing and include information relevant to debugging the at least one test failure. For example, the reports may include information related to the environment, steps to reproduce the test failure(s), expected result, actual results, screenshot(s), and/or other information. In some embodiments, the operation(s) for addressing the at least one test failure may include providing the second output indicative of the second context to additional model(s), which is discussed in more detail below with respect to FIG. 4.

Now referring to FIG. 4, FIG. 4 is a flow diagram showing an example method 400 for addressing root cause failures for automated testing, in accordance with some embodiments of the present disclosure. Each block of method 400, described herein, comprises a computing process that may be performed using any combination of hardware, firmware, and/or software. For instance, various functions may be carried out by a processor executing instructions stored in memory. The method may also be embodied as computer-usable instructions stored on computer storage media. The method may be provided by a standalone application, a service or hosted service (standalone or in combination with another hosted service), or a plug-in to another product, to name a few. In addition, method 400 is described, by way of example, with respect to the system of FIGS. 1A-2. However, this method may additionally or alternatively be executed by any one system, or any combination of systems, including, but not limited to, those described herein.

The method 400, at block B402, includes identifying, using third model(s), one or more portions of code as being relevant to the at least one test failure based at least on the second output indicative of the second context extracted from the product log(s), the third prompt(s), and information retrieved from one or more third databases. The code may correspond to the source code for the product being tested using automated testing. For example, the source code may include a subset of the code for the product that is specific to the functionality being tested using the test script(s) executed during the automated testing. The test script(s) may correspond to the test log(s) and the product log(s) and may include instructions that may be executed to simulate interactions with the product under testing, compare the results of the execution with expected outcomes, and report the status of the test when executed (e.g., in the test log(s)).

The third model(s) may comprise one or more neural networks (e.g., a LM RAG model) that identify portion(s) of the code based on the second context, the third prompt(s), and information retrieved from the third database(s). The third prompt(s) may include a predetermined system prompt describing a role for the third model(s). For example, the predetermined system prompt may assign a role of a product developer to the third model(s) and tasks to perform for identifying portion(s) of code that are relevant to the at least one test failure and generating proposed code change(s). The third model(s) may retrieve the third information that is relevant to the code from third database(s) using third retriever(s), which may comprise a third retrieval ensemble that includes a third syntactic retriever and a code retriever. The third retriever(s) may identify information from the third database(s) that is relevant to the code based on a similarity between vector embeddings generated from the code and vector embeddings stored in the third database(s). The information may correspond to past source code for the product and/or portion(s) of the test scripts identified as being relevant to the test failure(s) in the second context.

The method 400, at block B404, includes generating one or more proposed code changes based at least on the portion(s) of the code identified as being relevant to the at least one test failure. The third model(s) may generate proposed source code changes that will fix the test failure(s) included in the output indicative of the second context extracted from the product logs. The proposed code change(s) may include proposed source code change(s) for the product being tested, which may be represented using a code difference output. The code difference output may include, for example, a copy of the previous version of the portion(s) of the source code and the proposed version of the portion(s) of the source code with the proposed source code changes. In some embodiments, the proposed code change(s) may include proposed test script change(s) that will fix the test failure(s) included in the output indicative of the second context extracted from the product logs. The proposed test script change(s) may be represented using a difference output, which may comprise a copy of the previous version of the portion(s) of the test scripts and the proposed version of the portion(s) of the test scripts. In some embodiments, the proposed code change(s) (e.g., proposed source code change(s) and/or test script change(s)) may be highlighted or otherwise differentiated to enable easier review of the proposed code change(s). The proposed code change(s) may be output for display and review by a user. For example, a user may review the proposed code change(s) and accept the proposed code change(s), reject the proposed code change(s), or modify the proposed code change(s).

In some examples, the machine learning model(s) (e.g., deep neural networks, language models, LLMs, SLMs, VLMs, multi-modal language models, vision-language-action (VLA) models, perception models, tracking models, fusion models, transformer models, diffusion models, encoder-only models, decoder-only models, encoder-decoder models, neural rendering field (NERF) models, etc.) described herein (e.g., used to implement the stages of the multi-stage root cause analysis RAG system 100) may be packaged as a microservice—such an inference microservice (e.g., NVIDIA NIMs)—which may include a container (e.g., an operating system (OS)-level virtualization package) that may include an application programming interface (API) layer, a server layer, a runtime layer, and/or a model “engine.” For example, the inference microservice may include the container itself and the model(s) (e.g., weights and biases). In some instances, such as where the machine learning model(s) is small enough (e.g., has a small enough number of parameters), the model(s) may be included within the container itself. In other examples—such as where the model(s) is large—the model(s) may be hosted/stored in the cloud (e.g., in a data center) and/or may be hosted on-premises and/or at the edge (e.g., on a local server or computing device, but outside of the container). In such embodiments, the model(s) may be accessible via one or more APIs—such as REST APIs. As such, and in some embodiments, the machine learning model(s) described herein may be deployed as an inference microservice to accelerate deployment of a model(s) on any cloud, data center, or edge computing system, while ensuring the data is secure. For example, the inference microservice may include one or more APIs, a pre-configured container for simplified deployment, an optimized inference engine (e.g., built using a standardized AI model deployment an execution software, such as NVIDIA's Triton Inference Server, and/or one or more APIs for high performance deep learning inference, which may include an inference runtime and model optimizations that deliver low latency and high throughput for production applications—such as NVIDIA's TensorRT), and/or enterprise management data for telemetry (e.g., including identity, metrics, health checks, and/or monitoring). The machine learning model(s) described herein may be included as part of the microservice along with an accelerated infrastructure with the ability to deploy with a single command and/or orchestrate and auto-scale with a container orchestration system on accelerated infrastructure (e.g., on a single device up to data center scale). As such, the inference microservice may include the machine learning model(s) (e.g., that has been optimized for high performance inference), an inference runtime software to execute the machine learning model(s) and provide outputs/responses to inputs (e.g., user queries, prompts, etc.), and enterprise management software to provide health checks, identity, and/or other monitoring. In some embodiments, the inference microservice may include software to perform in-place replacement and/or updating to the machine learning model(s). When replacing or updating, the software that performs the replacement/updating may maintain user configurations of the inference runtime software and enterprise management software.

The systems and methods described herein may be used for a variety of purposes, by way of example and without limitation, for machine (e.g., robot, vehicle, construction machinery, warehouse vehicles/machines, autonomous, semi-autonomous, and/or other machine types) control, machine locomotion, machine driving, synthetic data generation, model training (e.g., using real, augmented, and/or synthetic data, such as synthetic data generated using a simulation platform or system, synthetic data generation techniques such as but not limited to those described herein, etc.), perception, augmented reality (AR), virtual reality (VR), mixed reality (MR), robotics, security and surveillance (e.g., in a smart cities implementation), autonomous or semi-autonomous machine applications, deep learning, environment simulation, object or actor simulation and/or digital twinning, data center processing, conversational AI, light transport simulation (e.g., ray-tracing, path tracing, etc.), distributed or collaborative content creation for 3D assets (e.g., using universal scene descriptor (USD) data, such as OpenUSD, and/or other data types), cloud computing, generative artificial intelligence (e.g., using one or more diffusion models, transformer models, etc.), and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot or robotic platform, aerial systems, medial systems, boating systems, smart area monitoring systems, systems for performing deep learning operations, systems for performing simulation operations (e.g., in a driving or vehicle simulation, in a robotics simulation, in a smart cities or surveillance simulation, etc.), systems for performing digital twin operations (e.g., in conjunction with a collaborative content creation platform or system, such as, without limitation, NVIDIA's OMNIVERSE and/or another platform, system, or service that uses USD or OpenUSD data types), systems implemented using an edge device, systems incorporating one or more virtual machines (VMs), systems for performing synthetic data generation operations (e.g., using one or more neural rendering fields (NERFs), Gaussian splat techniques, diffusion models, transformer models, etc.), systems implemented at least partially in a data center, systems for performing conversational AI operations, systems implementing one or more language models—such as one or more large language models (LLMs), one or more small language models (SLMs), one or more vision language models (VLMs), one or more multi-modal language models (MMLMs), etc., systems for performing light transport simulation, systems for performing collaborative content creation for 3D assets (e.g., using universal scene descriptor (USD) data, such as OpenUSD, computer aided design (CAD) data, 2D and/or 3D graphics or design data, and/or other data types), systems implemented at least partially using cloud computing resources, and/or other types of systems.

### Example Language Models

In at least some embodiments, language models, such as large language models (LLMs), small language models (SLMs), vision language models (VLMs), multi-modal language models (MMLMs), and/or other types of generative artificial intelligence (AI) may be implemented. In some embodiments, one or more functions of the multi-stage root cause analysis RAG system 100 described herein may be implemented, at least in part, using language models. These models may be capable of understanding, summarizing, translating, and/or otherwise generating text (e.g., natural language text, code, etc.), images, video, computer aided design (CAD) assets, OMNIVERSE and/or METAVERSE file information (e.g., in USD format, such as OpenUSD), and/or the like, based on the context provided in input prompts or queries. These language models may be considered “large,” in embodiments, based on the models being trained on massive datasets and having architectures with large number of learnable network parameters (weights and biases)—such as millions or billions of parameters. The LLMs/SLMs/VLMs/MMLMs/etc. may be implemented for summarizing textual data, analyzing and extracting insights from data (e.g., textual, image, video, etc.), and generating new text/image/video/etc. in user-specified styles, tones, and/or formats. The LLMs/SLMs/VLMs/MMLMs/etc. of the present disclosure may be used exclusively for text processing, in embodiments, whereas in other embodiments, multi-modal LLMs may be implemented to accept, understand, and/or generate text and/or other types of content like images, audio, 2D and/or 3D data (e.g., in USD formats), and/or video. For example, vision language models (VLMs), or more generally multi-modal language models (MMLMs), may be implemented to accept image, video, audio, textual, 3D design (e.g., CAD), and/or other inputs data types and/or to generate or output image, video, audio, textual, 3D design, and/or other output data types.

Various types of LLMs/SLMs/VLMs/MMLMs/etc. architectures may be implemented in various embodiments. For example, different architectures may be implemented that use different techniques for understanding and generating outputs—such as text, audio, video, image, 2D and/or 3D design or asset data, etc. In some embodiments, LLMs/SLMs/VLMs/MMLMs/etc. architectures such as recurrent neural networks (RNNs) or long short-term memory networks (LSTMs) may be used, while in other embodiments transformer architectures—such as those that rely on self-attention and/or cross-attention (e.g., between contextual data and textual data) mechanisms—may be used to understand and recognize relationships between words or tokens and/or contextual data (e.g., other text, video, image, design data, USD, etc.). One or more generative processing pipelines that include LLMs/SLMs/VLMs/MMLMs/etc. may also include one or more diffusion block(s) (e.g., denoisers). The LLMs/SLMs/VLMs/MMLMs/etc. of the present disclosure may include encoder and/or decoder block(s). For example, discriminative or encoder-only models like BERT (Bidirectional Encoder Representations from Transformers) may be implemented for tasks that involve language comprehension such as classification, sentiment analysis, question answering, and named entity recognition. As another example, generative or decoder-only models like GPT (Generative Pretrained Transformer) may be implemented for tasks that involve language and content generation such as text completion, story generation, and dialogue generation. LLMs/SLMs/VLMs/MMLMs/etc. that include both encoder and decoder components like T5 (Text-to-Text Transformer) may be implemented to understand and generate content, such as for translation and summarization. These examples are not intended to be limiting, and any architecture type—including but not limited to those described herein—may be implemented depending on the particular embodiment and the task(s) being performed using the LLMs/SLMs/VLMs/MMLMs/etc.

In various embodiments, the LLMs/SLMs/VLMs/MMLMs/etc. may be trained using unsupervised learning, in which LLMs/SLMs/VLMs/MMLMs/etc. learn patterns from large amounts of unlabeled text/audio/video/image/design/USD/etc. data. Due to the extensive training, in embodiments, the models may not require task-specific or domain-specific training. LLMs/SLMs/VLMs/MMLMs/etc. that have undergone extensive pre-training on vast amounts of unlabeled data may be referred to as foundation models and may be adept at a variety of tasks like question-answering, summarization, filling in missing information, translation, image/video/design/USD/data generation. Some LLMs/SLMs/VLMs/MMLMs/etc. may be tailored for a specific use case using techniques like prompt tuning, fine-tuning, retrieval augmented generation (RAG), adding adapters (e.g., customized neural networks, and/or neural network layers, that tune or adjust prompts or tokens to bias the language model toward a particular task or domain), and/or using other fine-tuning or tailoring techniques that optimize the models for use on particular tasks and/or within particular domains.

In some embodiments, the LLMs/SLMs/VLMs/MMLMs/etc. of the present disclosure may be implemented using various model alignment techniques. For example, in some embodiments, guardrails may be implemented to identify improper or undesired inputs (e.g., prompts) and/or outputs of the models. In doing so, the system may use the guardrails and/or other model alignment techniques to either prevent a particular undesired input from being processed using the LLMs/SLMs/VLMs/MMLMs/etc., and/or preventing the output or presentation (e.g., display, audio output, etc.) of information generating using the LLMs/SLMs/VLMs/MMLMs/etc. In some embodiments, one or more additional models—or layers thereof—may be implemented to identify issues with inputs and/or outputs of the models. For example, these “safeguard” models may be trained to identify inputs and/or outputs that are “safe” or otherwise okay or desired and/or that are “unsafe” or are otherwise undesired for the particular application/implementation. As a result, the LLMs/SLMs/VLMs/MMLMs/etc. of the present disclosure may be less likely to output language/text/audio/video/design data/USD data/etc. that may be offensive, vulgar, improper, unsafe, out of domain, and/or otherwise undesired for the particular application/implementation.

In some embodiments, the LLMs/SLMs/VLMs/MMLMs/etc. may be configured to or capable of accessing or using one or more plug-ins, application programming interfaces (APIs), databases, data stores, repositories, etc. For example, for certain tasks or operations that the model is not ideally suited for, the model may have instructions (e.g., as a result of training, and/or based on instructions in a given prompt) to access one or more plug-ins (e.g., 3^{rd} party plugins) for help in processing the current input. In such an example, where at least part of a prompt is related to restaurants or weather, the model may access one or more restaurant or weather plug-ins (e.g., via one or more APIs) to retrieve the relevant information. As another example, where at least part of a response requires a mathematical computation, the model may access one or more math plug-ins or APIs for help in solving the problem(s), and may then use the response from the plug-in and/or API in the output from the model. This process may be repeated—e.g., recursively—for any number of iterations and using any number of plug-ins and/or APIs until a response to the input prompt can be generated that addresses each ask/question/request/process/operation/etc. As such, the model(s) may not only rely on its own knowledge from training on a large dataset(s), but also on the expertise or optimized nature of one or more external resources—such as APIs, plug-ins, and/or the like.

In some embodiments, multiple language models (e.g., LLMs/SLMs/VLMs/MMLMs/etc., multiple instances of the same language model, and/or multiple prompts provided to the same language model or instance of the same language model may be implemented, executed, or accessed (e.g., using one or more plug-ins, user interfaces, APIs, databases, data stores, repositories, etc.) to provide output responsive to the same query, or responsive to separate portions of a query. In at least one embodiment, multiple language models e.g., language models with different architectures, language models trained on different (e.g., updated) corpuses of data may be provided with the same input query and prompt (e.g., set of constraints, conditioners, etc.). In one or more embodiments, the language models may be different versions of the same foundation model. In one or more embodiments, at least one language model may be instantiated as multiple agents—e.g., more than one prompt may be provided to constrain, direct, or otherwise influence a style, a content, or a character, etc., of the output provided. In one or more example, non-limiting embodiments, the same language model may be asked to provide output corresponding to a different role, perspective, character, or having a different base of knowledge, etc.—as defined by a supplied prompt.

In any one of such embodiments, the output of two or more (e.g., each) language models, two or more versions of at least one language model, two or more instanced agents of at least one language model, and/or two more prompts provided to at least one language model may be further processed, e.g., aggregated, compared or filtered against, or used to determine (and provide) a consensus response. In one or more embodiments, the output from one language model—or version, instance, or agent—maybe be provided as input to another language model for further processing and/or validation. In one or more embodiments, a language model may be asked to generate or otherwise obtain an output with respect to an input source material, with the output being associated with the input source material. Such an association may include, for example, the generation of a caption or portion of text that is embedded (e.g., as metadata) with an input source text or image. In one or more embodiments, an output of a language model may be used to determine the validity of an input source material for further processing, or inclusion in a dataset. For example, a language model may be used to assess the presence (or absence) of a target word in a portion of text or an object in an image, with the text or image being annotated to note such presence (or lack thereof). Alternatively, the determination from the language model may be used to determine whether the source material should be included in a curated dataset, for example and without limitation.

FIG. 5A is a block diagram of an example generative language model system 500 suitable for use in implementing at least some embodiments of the present disclosure. In the example illustrated in FIG. 5A, the generative language model system 500 includes a retrieval augmented generation (RAG) component 592, an input processor 505, a tokenizer 510, an embedding component 520, plug-ins/APIs 595, and a generative language model (LM) 530 (which may include an LLM, a SLM, a VLM, a multi-modal LM, etc.). In some embodiments, the first stage 102, the second stage 104, and/or the third stage 150 of the multi-stage root cause analysis RAG system 100 described herein may be implemented using features similar to those of the generative language model system 500.

At a high level, the input processor 505 may receive an input 501 comprising text and/or other types of input data (e.g., audio data, video data, image data, sensor data (e.g., LiDAR, RADAR, ultrasonic, etc.), 3D design data, CAD data, universal scene descriptor (USD) data such as OpenUSD, etc.), depending on the architecture of the generative LM 530 (e.g., LLM/SLM/VLM/MMLM/etc.). In some embodiments, the input 501 includes plain text in the form of one or more sentences, paragraphs, and/or documents. Additionally or alternatively, the input 501 may include numerical sequences, precomputed embeddings (e.g., word or sentence embeddings), and/or structured data (e.g., in tabular formats, JSON, or XML). In some implementations in which the generative LM 530 is capable of processing multi-modal inputs, the input 501 may combine text (or may omit text) with image data, audio data, video data, design data, USD data, and/or other types of input data, such as but not limited to those described herein. Taking raw input text as an example, the input processor 505 may prepare raw input text in various ways. For example, the input processor 505 may perform various types of text filtering to remove noise (e.g., special characters, punctuation, HTML tags, stopwords, portions of an image(s), portions of audio, etc.) from relevant textual content. In an example involving stopwords (common words that tend to carry little semantic meaning), the input processor 505 may remove stopwords to reduce noise and focus the generative LM 530 on more meaningful content. The input processor 505 may apply text normalization, for example, by converting all characters to lowercase, removing accents, and/or or handling special cases like contractions or abbreviations to ensure consistency. These are just a few examples, and other types of input processing may be applied.

In some embodiments, a RAG component 592 (which may include one or more RAG models, and/or may be performed using the generative LM 530 itself) may be used to retrieve additional information to be used as part of the input 501 or prompt. RAG may be used to enhance the input to the LLM/SLM/VLM/MMLM/etc. with external knowledge, so that answers to specific questions or queries or requests are more relevant—such as in a case where specific knowledge is required. The RAG component 592 may fetch this additional information (e.g., grounding information, such as grounding text/image/video/audio/USD/CAD/etc.) from one or more external sources, which can then be fed to the LLM/SLM/VLM/MMLM/etc. along with the prompt to improve accuracy of the responses or outputs of the model.

For example, in some embodiments, the input 501 may be generated using the query or input to the model (e.g., a question, a request, etc.) in addition to data retrieved using the RAG component 592. In some embodiments, the input processor 505 may analyze the input 501 and communicate with the RAG component 592 (or the RAG component 592 may be part of the input processor 505, in embodiments) in order to identify relevant text and/or other data to provide to the generative LM 530 as additional context or sources of information from which to identify the response, answer, or output 590, generally. For example, where the input indicates that the user is interested in a desired tire pressure for a particular make and model of vehicle, the RAG component 592 may retrieve—using a RAG model performing a vector search in an embedding space, for example—the tire pressure information or the text corresponding thereto from a digital (embedded) version of the user manual for that particular vehicle make and model. Similarly, where a user revisits a chatbot related to a particular product offering or service, the RAG component 592 may retrieve a prior stored conversation history—or at least a summary thereof—and include the prior conversation history along with the current ask/request as part of the input 501 to the generative LM 530.

The RAG component 592 may use various RAG techniques. For example, naïve RAG may be used where documents are indexed, chunked, and applied to an embedding model to generate embeddings corresponding to the chunks. A user query may also be applied to the embedding model and/or another embedding model of the RAG component 592 and the embeddings of the chunks along with the embeddings of the query may be compared to identify the most similar/related embeddings to the query, which may be supplied to the generative LM 530 to generate an output.

In some embodiments, more advanced RAG techniques may be used. For example, prior to passing chunks to the embedding model, the chunks may undergo pre-retrieval processes (e.g., routing, rewriting, metadata analysis, expansion, etc.). In addition, prior to generating the final embeddings, post-retrieval processes (e.g., re-ranking, prompt compression, etc.) may be performed on the outputs of the embedding model prior to final embeddings being used as comparison to an input query.

As a further example, modular RAG techniques may be used, such as those that are similar to naïve and/or advanced RAG, but also include features such as hybrid search, recursive retrieval and query engines, StepBack approaches, sub-queries, and hypothetical document embedding.

As another example, Graph RAG may use knowledge graphs as a source of context or factual information. Graph RAG may be implemented using a graph database as a source of contextual information sent to the LLM/SLM/VLM/MMLM/etc. Rather than (or in addition to) providing the model with chunks of data extracted from larger sized documents—which may result in a lack of context, factual correctness, language accuracy, etc.—graph RAG may also provide structured entity information to the LLM/SLM/VLM/MMLM/etc. by combining the structured entity textual description with its many properties and relationships, allowing for deeper insights by the model. When implementing graph RAG, the systems and methods described herein use a graph as a content store and extract relevant chunks of documents and ask the LLM/SLM/VLM/MMLM/etc. to answer using them. The knowledge graph, in such embodiments, may contain relevant textual content and metadata about the knowledge graph as well as be integrated with a vector database. In some embodiments, the graph RAG may use a graph as a subject matter expert, where descriptions of concepts and entities relevant to a query/prompt may be extracted and passed to the model as semantic context. These descriptions may include relationships between the concepts. In other examples, the graph may be used as a database, where part of a query/prompt may be mapped to a graph query, the graph query may be executed, and the LLM/SLM/VLM/MMLM/etc. may summarize the results. In such an example, the graph may store relevant factual information, and a query (natural language query) to graph query tool (NL-to-Graph-query tool) and entity linking may be used. In some embodiments, graph RAG (e.g., using a graph database) may be combined with standard (e.g., vector database) RAG, and/or other RAG types, to benefit from multiple approaches.

In any embodiments, the RAG component 592 may implement a plugin, API, user interface, and/or other functionality to perform RAG. For example, a graph RAG plug-in may be used by the LLM/SLM/VLM/MMLM/etc. to run queries against the knowledge graph to extract relevant information for feeding to the model, and a standard or vector RAG plug-in may be used to run queries against a vector database. For example, the graph database may interact with a plug-in's REST interface such that the graph database is decoupled from the vector database and/or the embeddings models.

The tokenizer 510 may segment the (e.g., processed) text data into smaller units (tokens) for subsequent analysis and processing. The tokens may represent individual words, subwords, characters, portions of audio/video/image/etc., depending on the implementation. Word-based tokenization divides the text into individual words, treating each word as a separate token. Subword tokenization breaks down words into smaller meaningful units (e.g., prefixes, suffixes, stems), enabling the generative LM 530 to understand morphological variations and handle out-of-vocabulary words more effectively. Character-based tokenization represents each character as a separate token, enabling the generative LM 530 to process text at a fine-grained level. The choice of tokenization strategy may depend on factors such as the language being processed, the task at hand, and/or characteristics of the training dataset. As such, the tokenizer 510 may convert the (e.g., processed) text into a structured format according to tokenization schema being implemented in the particular embodiment.

The embedding component 520 may use any known embedding technique to transform discrete tokens into (e.g., dense, continuous vector) representations of semantic meaning. For example, the embedding component 520 may use pre-trained word embeddings (e.g., Word2Vec, GloVe, or FastText), one-hot encoding, Term Frequency-Inverse Document Frequency (TF-IDF) encoding, one or more embedding layers of a neural network, and/or otherwise.

In some implementations in which the input 501 includes image data/video data/etc., the input processor 505 may resize the data to a standard size compatible with format of a corresponding input channel and/or may normalize pixel values to a common range (e.g., 0 to 1) to ensure a consistent representation, and the embedding component 520 may encode the image data using any known technique (e.g., using one or more convolutional neural networks (CNNs) to extract visual features). In some implementations in which the input 501 includes audio data, the input processor 505 may resample an audio file to a consistent sampling rate for uniform processing, and the embedding component 520 may use any known technique to extract and encode audio features—such as in the form of a spectrogram (e.g., a mel-spectrogram). In some implementations in which the input 501 includes video data, the input processor 505 may extract frames or apply resizing to extracted frames, and the embedding component 520 may extract features such as optical flow embeddings or video embeddings and/or may encode temporal information or sequences of frames. In some implementations in which the input 501 includes multi-modal data, the embedding component 520 may fuse representations of the different types of data (e.g., text, image, audio, USD, video, design, etc.) using techniques like early fusion (concatenation), late fusion (sequential processing), attention-based fusion (e.g., self-attention, cross-attention), etc.

The generative LM 530 and/or other components of the generative LM system 500 may use different types of neural network architectures depending on the implementation. For example, transformer-based architectures such as those used in models like GPT may be implemented, and may include self-attention mechanisms that weigh the importance of different words or tokens in the input sequence and/or feedforward networks that process the output of the self-attention layers, applying non-linear transformations to the input representations and extracting higher-level features. Some non-limiting example architectures include transformers (e.g., encoder-decoder, decoder only, multi-modal), RNNs, LSTMs, fusion models, diffusion models, cross-modal embedding models that learn joint embedding spaces, graph neural networks (GNNs), hybrid architectures combining different types of architectures adversarial networks like generative adversarial networks or GANs or adversarial autoencoders (AAEs) for joint distribution learning, and others. As such, depending on the implementation and architecture, the embedding component 520 may apply an encoded representation of the input 501 to the generative LM 530, and the generative LM 530 may process the encoded representation of the input 501 to generate an output 590, which may include responsive text and/or other types of data.

As described herein, in some embodiments, the generative LM 530 may be configured to access or use—or capable of accessing or using—plug-ins/APIs 595 (which may include one or more plug-ins, application programming interfaces (APIs), databases, data stores, repositories, etc.). For example, for certain tasks or operations that the generative LM 530 is not ideally suited for, the model may have instructions (e.g., as a result of training, and/or based on instructions in a given prompt, such as those retrieved using the RAG component 592) to access one or more plug-ins/APIs 595 (e.g., 3^{rd} party plugins) for help in processing the current input. In such an example, where at least part of a prompt is related to restaurants or weather, the model may access one or more restaurant or weather plug-ins (e.g., via one or more APIs), send at least a portion of the prompt related to the particular plug-in/API 595 to the plug-in/API 595, the plug-in/API 595 may process the information and return an answer to the generative LM 530, and the generative LM 530 may use the response to generate the output 590. This process may be repeated—e.g., recursively—for any number of iterations and using any number of plug-ins/APIs 595 until an output 590 that addresses each ask/question/request/process/operation/etc. from the input 501 can be generated. As such, the model(s) may not only rely on its own knowledge from training on a large dataset(s) and/or from data retrieved using the RAG component 592, but also on the expertise or optimized nature of one or more external resources—such as the plug-ins/APIs 595.

FIG. 5B is a block diagram of an example implementation in which the generative LM 530 includes a transformer encoder-decoder. For example, assume input text such as “Who discovered gravity” is tokenized (e.g., by the tokenizer510 of FIG. 5A) into tokens such as words, and each token is encoded (e.g., by the embedding component 520 of FIG. 95A) into a corresponding embedding (e.g., of size 512). Since these token embeddings typically do not represent the position of the token in the input sequence, any known technique may be used to add a positional encoding to each token embedding to encode the sequential relationships and context of the tokens in the input sequence. As such, the (e.g., resulting) embeddings may be applied to one or more encoder(s) 535 of the generative LM 530.

In an example implementation, the encoder(s) 535 forms an encoder stack, where each encoder includes a self-attention layer and a feedforward network. In an example transformer architecture, each token (e.g., word) flows through a separate path. As such, each encoder may accept a sequence of vectors, passing each vector through the self-attention layer, then the feedforward network, and then upwards to the next encoder in the stack. Any known self-attention technique may be used. For example, to calculate a self-attention score for each token (word), a query vector, a key vector, and a value vector may be created for each token, a self-attention score may be calculated for pairs of tokens by taking the dot product of the query vector with the corresponding key vectors, normalizing the resulting scores, multiplying by corresponding value vectors, and summing weighted value vectors. The encoder may apply multi-headed attention in which the attention mechanism is applied multiple times in parallel with different learned weight matrices. Any number of encoders may be cascaded to generate a context vector encoding the input. An attention projection layer 540 may convert the context vector into attention vectors (keys and values) for the decoder(s) 545.

In an example implementation, the decoder(s) 545 form a decoder stack, where each decoder includes a self-attention layer, an encoder-decoder self-attention layer that uses the attention vectors (keys and values) from the encoder to focus on relevant parts of the input sequence, and a feedforward network. As with the encoder(s) 535, in an example transformer architecture, each token (e.g., word) flows through a separate path in the decoder(s) 545. During a first pass, the decoder(s) 545, a classifier 550, and a generation mechanism 555 may generate a first token, and the generation mechanism 555 may apply the generated token as an input during a second pass. The process may repeat in a loop, successively generating and adding tokens (e.g., words) to the output from the preceding pass and applying the token embeddings of the composite sequence with positional encodings as an input to the decoder(s) 545 during a subsequent pass, sequentially generating one token at a time (known as auto-regression) until predicting a symbol or token that represents the end of the response. Within each decoder, the self-attention layer is typically constrained to attend only to preceding positions in the output sequence by applying a masking technique (e.g., setting future positions to negative infinity) before the softmax operation. In an example implementation, the encoder-decoder attention layer operates similarly to the (e.g., multi-headed) self-attention in the encoder(s) 535, except that it creates its queries from the layer below it and takes the keys and values (e.g., matrix) from the output of the encoder(s) 535.

As such, the decoder(s) 545 may output some decoded (e.g., vector) representation of the input being applied during a particular pass. The classifier 550 may include a multi-class classifier comprising one or more neural network layers that project the decoded (e.g., vector) representation into a corresponding dimensionality (e.g., one dimension for each supported word or token in the output vocabulary) and a softmax operation that converts logits to probabilities. As such, the generation mechanism 555 may select or sample a word or token based on a corresponding predicted probability (e.g., select the word with the highest predicted probability) and append it to the output from a previous pass, generating each word or token sequentially. The generation mechanism 555 may repeat the process, triggering successive decoder inputs and corresponding predictions until selecting or sampling a symbol or token that represents the end of the response, at which point, the generation mechanism 555 may output the generated response.

FIG. 5C is a block diagram of an example implementation in which the generative LM 530 includes a decoder-only transformer architecture. For example, the decoder(s) 560 of FIG. 5C may operate similarly as the decoder(s) 545 of FIG. 5B except each of the decoder(s) 560 of FIG. 5C omits the encoder-decoder self-attention layer (since there is no encoder in this implementation). As such, the decoder(s) 560 may form a decoder stack, where each decoder includes a self-attention layer and a feedforward network. Furthermore, instead of encoding the input sequence, a symbol or token representing the end of the input sequence (or the beginning of the output sequence) may be appended to the input sequence, and the resulting sequence (e.g., corresponding embeddings with positional encodings) may be applied to the decoder(s) 560. As with the decoder(s) 545 of FIG. 5B, each token (e.g., word) may flow through a separate path in the decoder(s) 560, and the decoder(s) 560, a classifier 565, and a generation mechanism 570 may use auto-regression to sequentially generate one token at a time until predicting a symbol or token that represents the end of the response. The classifier 565 and the generation mechanism 570 may operate similarly as the classifier 550 and the generation mechanism 555 of FIG. 5B, with the generation mechanism 570 selecting or sampling each successive output token based on a corresponding predicted probability and appending it to the output from a previous pass, generating each token sequentially until selecting or sampling a symbol or token that represents the end of the response. These and other architectures described herein are meant simply as examples, and other suitable architectures may be implemented within the scope of the present disclosure.

### Example Computing Device

FIG. 6 is a block diagram of an example computing device(s) 600 suitable for use in implementing some embodiments of the present disclosure. In some embodiments, one or more functions of the multi-stage root cause analysis RAG system 100 and/or the vector database generation system 200 described herein may be implemented, at least in part, using the computing device 600. Computing device 600 may include an interconnect system 602 that directly or indirectly couples the following devices: memory 604, one or more central processing units (CPUs) 606, one or more graphics processing units (GPUs) 608, a communication interface 610, input/output (I/O) ports 612, input/output components 614, a power supply 616, one or more presentation components 618 (e.g., display(s)), and one or more logic units 620. In at least one embodiment, the computing device(s) 600 may comprise one or more virtual machines (VMs), and/or any of the components thereof may comprise virtual components (e.g., virtual hardware components). For non-limiting examples, one or more of the GPUs 608 may comprise one or more vGPUs, one or more of the CPUs 606 may comprise one or more vCPUs, and/or one or more of the logic units 620 may comprise one or more virtual logic units. As such, a computing device(s) 600 may include discrete components (e.g., a full GPU dedicated to the computing device 600), virtual components (e.g., a portion of a GPU dedicated to the computing device 600), or a combination thereof.

Although the various blocks of FIG. 6 are shown as connected via the interconnect system 602 with lines, this is not intended to be limiting and is for clarity only. For example, in some embodiments, a presentation component 618, such as a display device, may be considered an I/O component 614 (e.g., if the display is a touch screen). As another example, the CPUs 606 and/or GPUs 608 may include memory (e.g., the memory 604 may be representative of a storage device in addition to the memory of the GPUs 608, the CPUs 606, and/or other components). As such, the computing device of FIG. 6 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 6.

The interconnect system 602 may represent one or more links or busses, such as an address bus, a data bus, a control bus, or a combination thereof. The interconnect system 602 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 606 may be directly connected to the memory 604. Further, the CPU 606 may be directly connected to the GPU 608. Where there is direct, or point-to-point connection between components, the interconnect system 602 may include a PCIe link to carry out the connection. In these examples, a PCI bus need not be included in the computing device 600.

The memory 604 may include any of a variety of computer-readable media. The computer-readable media may be any available media that may be accessed by the computing device 600. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 604 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 600. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 606 may be configured to execute at least some of the computer-readable instructions to control one or more components of the computing device 600 to perform one or more of the methods and/or processes described herein. The CPU(s) 606 may each include one or more cores (e.g., one, two, four, eight, twenty-eight, seventy-two, etc.) that are capable of handling a multitude of software threads simultaneously. The CPU(s) 606 may include any type of processor, and may include different types of processors depending on the type of computing device 600 implemented (e.g., processors with fewer cores for mobile devices and processors with more cores for servers). For example, depending on the type of computing device 600, the processor may be an Advanced RISC Machines (ARM) processor implemented using Reduced Instruction Set Computing (RISC) or an x86 processor implemented using Complex Instruction Set Computing (CISC). The computing device 600 may include one or more CPUs 606 in addition to one or more microprocessors or supplementary co-processors, such as math co-processors.

In addition to or alternatively from the CPU(s) 606, the GPU(s) 608 may be configured to execute at least some of the computer-readable instructions to control one or more components of the computing device 600 to perform one or more of the methods and/or processes described herein. One or more of the GPU(s) 608 may be an integrated GPU (e.g., with one or more of the CPU(s) 606 and/or one or more of the GPU(s) 608 may be a discrete GPU. In embodiments, one or more of the GPU(s) 608 may be a coprocessor of one or more of the CPU(s) 606. The GPU(s) 608 may be used by the computing device 600 to render graphics (e.g., 3D graphics) or perform general purpose computations. For example, the GPU(s) 608 may be used for General-Purpose computing on GPUs (GPGPU). The GPU(s) 608 may include hundreds or thousands of cores that are capable of handling hundreds or thousands of software threads simultaneously. The GPU(s) 608 may generate pixel data for output images in response to rendering commands (e.g., rendering commands from the CPU(s) 606 received via a host interface). The GPU(s) 608 may include graphics memory, such as display memory, for storing pixel data or any other suitable data, such as GPGPU data. The display memory may be included as part of the memory 604. The GPU(s) 608 may include two or more GPUs operating in parallel (e.g., via a link). The link may directly connect the GPUs (e.g., using NVLINK) or may connect the GPUs through a switch (e.g., using NVSwitch). When combined together, each GPU 608 may generate pixel data or GPGPU data for different portions of an output or for different outputs (e.g., a first GPU for a first image and a second GPU for a second image). Each GPU may include its own memory, or may share memory with other GPUs. In some embodiments, one or more functions of the multi-stage root cause analysis RAG system 100 and/or the vector database generation system 200 described herein may be executed, at least in part, by the CPU(s) 606 and/or GPU(s) 608.

In addition to or alternatively from the CPU(s) 606 and/or the GPU(s) 608, the logic unit(s) 620 may be configured to execute at least some of the computer-readable instructions to control one or more components of the computing device 600 to perform one or more of the methods and/or processes described herein. In embodiments, the CPU(s) 606, the GPU(s) 608, and/or the logic unit(s) 620 may discretely or jointly perform any combination of the methods, processes and/or portions thereof. One or more of the logic units 620 may be part of and/or integrated in one or more of the CPU(s) 606 and/or the GPU(s) 608 and/or one or more of the logic units 620 may be discrete components or otherwise external to the CPU(s) 606 and/or the GPU(s) 608. In embodiments, one or more of the logic units 620 may be a coprocessor of one or more of the CPU(s) 606 and/or one or more of the GPU(s) 608. In some embodiments, one or more functions of the multi-stage root cause analysis RAG system 100 and/or the vector database generation system 200 described herein may be executed, at least in part, by the logic unit(s) 620.

Examples of the logic unit(s) 620 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Programmable Vision Accelerator (PVAs)—which may include one or more direct memory access (DMA) systems, one or more vision or vector processing units (VPUs), one or more pixel processing engines (PPEs)—e.g., including a 2D array of processing elements that each communicate north, south, east, and west with one or more other processing elements in the array, one or more decoupled accelerators or units (e.g., decoupled lookup table (DLUT) accelerators or units), etc., Vision Processing Units (VPUs), Optical Flow Accelerators (OFAs), Field Programmable Gate Arrays (FPGAs), Neuromorphic Chips, Quantum Processing Units (QPUs), Associative Process Units (APUs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 610 may include one or more receivers, transmitters, and/or transceivers that allow the computing device 600 to communicate with other computing devices via an electronic communication network, included wired and/or wireless communications. The communication interface 610 may include components and functionality to allow communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 620 and/or communication interface 610 may include one or more data processing units (DPUs) to transmit data received over a network and/or through interconnect system 602 directly to (e.g., a memory of) one or more GPU(s) 608.

The I/O ports 612 may allow the computing device 600 to be logically coupled to other devices including the I/O components 614, the presentation component(s) 618, and/or other components, some of which may be built in to (e.g., integrated in) the computing device 600. Illustrative I/O components 614 include a microphone, mouse, keyboard, joystick, game pad, game controller, satellite dish, scanner, printer, wireless device, etc. The I/O components 614 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 600. The computing device 600 may be include depth cameras, such as stereoscopic camera systems, infrared camera systems, RGB camera systems, touchscreen technology, and combinations of these, for gesture detection and recognition. Additionally, the computing device 600 may include accelerometers or gyroscopes (e.g., as part of an inertia measurement unit (IMU)) that allow detection of motion. In some examples, the output of the accelerometers or gyroscopes may be used by the computing device 600 to render immersive augmented reality or virtual reality.

The power supply 616 may include a hard-wired power supply, a battery power supply, or a combination thereof. The power supply 616 may provide power to the computing device 600 to allow the components of the computing device 600 to operate.

The presentation component(s) 618 may include a display (e.g., a monitor, a touch screen, a television screen, a heads-up-display (HUD), other display types, or a combination thereof), speakers, and/or other presentation components. The presentation component(s) 618 may receive data from other components (e.g., the GPU(s) 608, the CPU(s) 606, DPUs, etc.), and output the data (e.g., as an image, video, sound, etc.).

### Example Data Center

FIG. 7 illustrates an example data center 700 that may be used in at least one embodiments of the present disclosure. The data center 700 may include a data center infrastructure layer 710, a framework layer 720, a software layer 730, and/or an application layer 740.

As shown in FIG. 7, the data center infrastructure layer 710 may include a resource orchestrator 712, grouped computing resources 714, and node computing resources (“node C.R.s”) 716(1)-716(N), where “N” represents any whole, positive integer. In at least one embodiment, node C.R.s 716(1)-716(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R. s from among node C.R.s 716(1)-716(N) may correspond to a server having one or more of the above-mentioned computing resources. In addition, in some embodiments, the node C.R.s 716(1)-716(N) may include one or more virtual components, such as vGPUs, vCPUs, and/or the like, and/or one or more of the node C.R.s 716(1)-716(N) may correspond to a virtual machine (VM). In some embodiments, one or more functions of the multi-stage root cause analysis RAG system 100 and/or the vector database generation system 200 described herein may be implemented, at least in part, using one or more of the node C.R.s 716(1)-716(N).

In at least one embodiment, grouped computing resources 714 may include separate groupings of node C.R.s 716 housed within one or more racks (not shown), or many racks housed in data centers at various geographical locations (also not shown). Separate groupings of node C.R.s 716 within grouped computing resources 714 may include grouped compute, network, memory or storage resources that may be configured or allocated to support one or more workloads. In at least one embodiment, several node C.R.s 716 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 712 may configure or otherwise control one or more node C.R.s 716(1)-716(N) and/or grouped computing resources 714. In at least one embodiment, resource orchestrator 712 may include a software design infrastructure (SDI) management entity for the data center 700. The resource orchestrator 712 may include hardware, software, or some combination thereof.

In at least one embodiment, as shown in FIG. 7, framework layer 720 may include a job scheduler 728, a configuration manager 734, a resource manager 736, and/or a distributed file system 738. The framework layer 720 may include a framework to support software 732 of software layer 730 and/or one or more application(s) 742 of application layer 740. The software 732 or application(s) 742 may respectively include web-based service software or applications, such as those provided by Amazon Web Services, Google Cloud and Microsoft Azure. The framework layer 720 may be, but is not limited to, a type of free and open-source software web application framework such as Apache Spark™ (hereinafter “Spark”) that may use distributed file system 738 for large-scale data processing (e.g., “big data”). In at least one embodiment, job scheduler 728 may include a Spark driver to facilitate scheduling of workloads supported by various layers of data center 700. The configuration manager 734 may be capable of configuring different layers such as software layer 730 and framework layer 720 including Spark and distributed file system 738 for supporting large-scale data processing. The resource manager 736 may be capable of managing clustered or grouped computing resources mapped to or allocated for support of distributed file system 738 and job scheduler 728. In at least one embodiment, clustered or grouped computing resources may include grouped computing resource 714 at data center infrastructure layer 710. The resource manager 736 may coordinate with resource orchestrator 712 to manage these mapped or allocated computing resources.

In at least one embodiment, software 732 included in software layer 730 may include software used by at least portions of node C.R.s 716(1)-716(N), grouped computing resources 714, and/or distributed file system 738 of framework layer 720. One or more types of software may include, but are not limited to, Internet web page search software, e-mail virus scan software, database software, and streaming video content software.

In at least one embodiment, application(s) 742 included in application layer 740 may include one or more types of applications used by at least portions of node C.R.s 716(1)-716(N), grouped computing resources 714, and/or distributed file system 738 of framework layer 720. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 734, resource manager 736, and resource orchestrator 712 may implement any number and type of self-modifying actions based on any amount and type of data acquired in any technically feasible fashion. Self-modifying actions may relieve a data center operator of data center 700 from making possibly bad configuration decisions and possibly avoiding underutilized and/or poor performing portions of a data center.

The data center 700 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 700. In at least one embodiment, trained or deployed machine learning models corresponding to one or more neural networks may be used to infer or predict information using resources described above with respect to the data center 700 by using weight parameters calculated through one or more training techniques, such as but not limited to those described herein.

In at least one embodiment, the data center 700 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 600 of FIG. 6—e.g., each device may include similar components, features, and/or functionality of the computing device(s) 600. In addition, where backend devices (e.g., servers, NAS, etc.) are implemented, the backend devices may be included as part of a data center 700, an example of which is described in more detail herein with respect to FIG. 7.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 600 described herein with respect to FIG. 6. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. One or more processors comprising processing circuitry to:
generate, using one or more first models, a first output indicative of a first context extracted from one or more test logs based at least on one or more first prompts and first information retrieved from one or more first databases, wherein the one or more test logs include a record of automated test execution for one or more tests and at least one test failure;
provide the first output indicative of the first context extracted from the one or more test logs, one or more second prompts, and one or more product logs as input to one or more second models, wherein the one or more product logs correspond to the one or more test logs and include a record of at least one event or action that occurred within a product during the one or more tests;
generate, using the one or more second models, a second output indicative of a second context extracted from the one or more product logs corresponding to the one or more test logs based at least on the first output indicative of the first context extracted from the one or more test logs, the one or more second prompts, and second information retrieved from one or more second databases; and
perform one or more operations for addressing the at least one test failure based at least on the second output indicative of the second context extracted from the one or more product logs.

2. The one or more processors of claim 1, wherein the first information retrieved from the one or more first databases comprises one or more first embeddings generated based at least on historical test logs, wherein the second information retrieved from the one or more second databases comprises one or more second embeddings generated based at least on historical product logs.

3. The one or more processors of claim 1, wherein the first output indicative of the first context extracted from the one or more test logs comprises at least one of a root cause of the at least one test failure in the one or more test logs, one or more steps that led to the at least one test failure, or test metadata.

4. The one or more processors of claim 1, wherein the second output indicative of the second context extracted from the one or more product logs comprises at least one of one or more error codes, a root cause of the at least one test failure in the one or more product logs, identification of functionality that failed, steps in the one or more product logs that led to the at least one test failure, or test metadata.

5. The one or more processors of claim 1, wherein the processing circuitry is further to:
retrieve the first information from the one or more first databases using a first retrieval ensemble comprising a first syntactic retriever and a first semantic retriever, wherein the first semantic retriever is weighted higher than the first syntactic retriever; and
retrieve the second information from the one or more second databases using a second retrieval ensemble comprising a second syntactic retriever and a second semantic retriever, wherein the second syntactic retriever is weighted higher than the second syntactic retriever.

6. The one or more processors of claim 1, wherein the one or more first prompts comprise a first role prompt describing a first role for the one or more first models, wherein the one or more second prompts comprise a second role prompt describing a second role for the one or more second models that is different than the first role for the one or more first models.

7. The one or more processors of claim 1, wherein the processing circuitry is to perform the one or more operations for addressing the at least one test failure by:
providing the second output indicative of the second context extracted from the one or more product logs, source code, and one or more third prompts as input to one or more third models;
identifying one or more portions of the source code as being relevant to the at least one test failure based at least on the second output indicative of the second context extracted from the one or more product logs, the one or more third prompts, and third information retrieved from one or more third databases;
generating one or more proposed changes to the source code based at least on the one or more portions of the source code identified as being relevant to the at least one test failure; and
outputting the one or more proposed changes to the source code.

8. The one or more processors of claim 7, wherein the processing circuitry is further to retrieve the third information from the one or more third databases using a retrieval ensemble comprising a syntactic retriever and a code retriever.

9. The one or more processors of claim 1, wherein the processing circuitry is further to:
receive one or more images corresponding to the one or more test logs;
generate textual information using one or more machine learning models based at least on the one or more images corresponding to the one or more test logs; and
wherein the processing circuitry is to generate the first output indicative of the first context extracted from the one or more test logs based at least on the one or more first prompts, the first information retrieved from the one or more first databases, and the textual information.

10. The one or more processors of claim 1, wherein the one or more operations for addressing the at least one test failure comprise generating a report that identifies a root cause of the at least one test failure and outputting the report for debugging source code.

11. The one or more processors of claim 1, wherein the one or more processors are comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system implementing one or more multi-modal language models;
a system implementing one or more large language models (LLMs);
a system implementing one or more small language models (SLMs);
a system implementing one or more vision language models (VLMs);
a system for generating synthetic data;
a system for generating synthetic data using AI;
a system incorporating one or more virtual machines (VMs);
a system using or deploying one or more inference microservices;
a system that incorporates one or more machine learning models deployed in a service or microservice along with an OS-level virtualization package;
a system implemented at least partially in a data center; or
a system implemented at least partially using cloud computing resources.

12. A system comprising one or more processors to:
generate, using one or more first models, a first context output based at least on one or more first prompts, one or more test logs, and first information retrieved from one or more first databases corresponding to the one or more test logs, wherein the one or more test logs include a record of automated test execution for one or more tests of a product and at least one test failure;
generate, using one or more second models, a second context output based at least on the first context output, one or more second prompts, one or more product logs, and second information retrieved from one or more second databases, wherein the one or more product logs correspond to the one or more test logs and include a record of at least one event or action that occurred within the product during the one or more tests of the product; and
perform one or more operations for addressing the at least one test failure based at least on the second context output.

13. The system of claim 12, wherein the one or more processors are further to:
retrieve the first information from the one or more first databases using a first retrieval ensemble comprising a first syntactic retriever and a first semantic retriever, wherein the first semantic retriever is weighted higher than the first syntactic retriever; and
retrieve the second information from the one or more second databases using a second retrieval ensemble comprising a second syntactic retriever and a second semantic retriever, wherein the second syntactic retriever is weighted higher than the second syntactic retriever.

14. The system of claim 12, wherein the one or more processors are to generate, using the one or more first models, the first context output based at least on one or more images captured during the one or more tests of the product.

15. The system of claim 12, wherein the second context output comprises at least one of: one or more error codes, a root cause of the at least one test failure in the one or more product logs, identification of functionality in the product that failed, steps in the one or more product logs that led to the at least one test failure, or test metadata.

16. The system of claim 12, wherein the one or more processors are to perform one or more operations for addressing the at least one test failure based at least on the second context output by:
identifying, using one or more third models, one or more portions of source code for the product as being relevant to the at least one test failure based at least on the second context output, one or more third prompts, and third information retrieved from one or more third databases;
generating, using the one or more third models, one or more proposed changes to the source code for the product based at least on the one or more portions of the source code for the product identified as being relevant to the at least one test failure, the one or more third prompts, and the third information retrieved from the one or more third databases; and
outputting the one or more proposed changes to the source code for the product.

17. The system of claim 16, wherein the one or more first prompts comprise a first role prompt describing a first role for the one or more first models, wherein the one or more second prompts comprise a second role prompt describing a second role for the one or more second models that is different than the first role, wherein the one or more third prompts comprise a third role prompt describing a third role for the one or more third models that is different than the first role and the second role.

18. The system of claim 12, wherein the one or more operations for addressing the at least one test failure comprise at least one of:
generating a report that identifies a root cause of the at least one test failure;
generating one or more proposed changes to a test script; or
generating one or more proposed changes to source code.

19. The system of claim 12, wherein the system is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system implementing one or more multi-modal language models;
a system implementing one or more large language models (LLMs);
a system implementing one or more small language models (SLMs);
a system implementing one or more vision language models (VLMs);
a system for generating synthetic data;
a system for generating synthetic data using AI;
a system incorporating one or more virtual machines (VMs);
a system using or deploying one or more inference microservices;
a system that incorporates one or more machine learning models deployed in a service or microservice along with an OS-level virtualization package;
a system implemented at least partially in a data center; or
a system implemented at least partially using cloud computing resources.

20. A method comprising:
performing one or more operations for addressing at least one test failure resulting in a software product during an automated test based at least on a first context extracted from one or more test logs and a second context extracted from one or more product logs, wherein the first context is extracted from the one or more test logs corresponding to the automated test using a plurality of models and based on one or more first prompts and first information retrieved from a plurality of databases, wherein the second context is extracted from the one or more product logs corresponding to the automated test using the plurality of models based at least on the first context, one or more second prompts, and second information retrieved from the plurality of databases.
